(19) United States
(12) Patent Application Publication
(10) Pub. No.: US 2021/0216279 A1
(43) Pub. Date: Jul. 15, 2021

(54) DATA PROCESSING SYSTEM, DATA PROCESSING APPARATUS, DATA PROCESSING METHOD, AND NON-TRANSITORY RECORDING MEDIUM

(71) Applicant: Esperant System Co., Ltd., Chiba (JP)

(72) Inventor: Shinji FURUSHO, Kanagawa (JP)

(21) Appl. No.: 17/216,847

(22) Filed: Mar. 30, 2021

Related U.S. Application Data
(63) Continuation of application No. PCT/JP2019/038757, filed on Oct. 1, 2019.

(30) Foreign Application Priority Data
Oct. 4, 2018 (JP) 2018-188966

(51) Int. Cl. G06F 7/08; G06F 16/22

(52) U.S. Cl. CPC G06F 7/08; G06F 16/2282

(57) ABSTRACT

In a system including nodes that store tables, respectively, each table storing one or more records, each node generates, from a table of the tables stored by an own node, a right structure used as a referred-side structure in an L-operation; generates, from the right structure, a left structure used as an operated-side structure in an L-operation; transmits the right structure generated by the own node to another node; receives a right structure generated by another node; performs an L-operation between the left structure and each of the right structure generated by the own node and the right structure received by the own node, and determines, for the one or more records stored by the table stored by the own node, corresponding positions in an order of all records stored by the tables that are stored by the nodes, respectively.

### CROSS-REFERENCE TO RELATED APPLICATION

The present application is a continuation filed under 35 U.S.C. 111 (a) claiming the benefit under 35 U.S.C. 120 and 365 (c) of PCT International Application No. PCT/JP2019/038757 filed on Oct. 1, 2019, and designating the U.S., which is based on and claims priority to Japanese Patent Application No. 2018-188966 filed on Oct. 4, 2018. The entire contents of the foregoing applications are incorporated herein by reference.

### BACKGROUND OF THE INVENTION

### 1. Field of the Invention

The present invention relates to a data processing system, a data processing apparatus, a data processing method, and a non-transitory recording medium.

### 2. Description of the Related Art

An ordered set where an order is defined among respective elements is expressed by records and a table that stores the records. In this regard, in order to sort the respective elements (records) of an ordered set, various methods are known. These methods will now be described for a case of sorting, in an ascending order of “age”, a plurality of records including data items of “age”, “gender”, and “address”.

As a first method, a method of changing the record storing positions of records in a table can be cited. In this case, as illustrated in FIG. 1A, the record storing positions can be changed through sorting. For example, the record (of age “8”) at the storing position “0” before the sorting is stored at the storing position “2” after the sorting.

As a second method, a method of using a record number list where record numbers (hereinafter, that may be referred to as “RecNos”) indicating an order among the records are stored. In this regard, the record number list stores a record number of the same storing position as that of a record. That is, at the storing position “n” of the record number list, the record number of the record at the storing position “n” of the table is stored. In this case, as illustrated in FIG. 1B, through sorting, the storing positions of the record numbers can be changed. For example, the record number “0” is stored at the storing position “0” of the record number list before sorting whereas after the sorting, the record number “0” is stored at the storing position “2” of the record number list. According to the second method, even for a case where a record size is large, a memory copying amount is smaller and a process is implemented at a higher speed in comparison to the first method. In addition, it is possible to express a proper subset (for example, an ordered set including only records having genders “F”) while leaving an original table unchanged.

As a third method, a method of, for a case where records are stored in a plurality of tables in a distributed manner, sorting the records using a GOrd (i.e., an abbreviation of a “Global Order”) representing a global order of the records among these tables is known (see Patent Reference 1). For example, as illustrated in FIG. 2, there are a table 1 and a table 2; the records stored in these tables 1 and 2 will be sorted. In such a case, a GOrd is determined in such a manner that the GOrd will represent an ascending order in one table and will represent a global order among the tables 1 and 2. For example, the record having the GOrd value “0” is the record having the record number “3” in the table 1. Similarly, for example, the record having the GOrd value “1” is the record having the record number “1” in the table 1. Similarly, for example, the record having the GOrd value “2” is the record having the record number “3” in the table 2. Also for the GOrd values “3” through “7”, the same way is applied. According to the third method, similarly to the second method, it is possible to implement a process at a high speed, and also, it is possible to express a proper subset while leaving an original table unchanged. In addition, because GOrd values have an ascending order in one table, search of the records can be implemented at a high speed.

### PRIOR ART DOCUMENT

### Patent Document

### Patent Document No. 1: Japanese Patent No. 4620593

### SUMMARY OF THE INVENTION

### Technical Problem

However, the above-mentioned first through third methods are advantageous for a case of sorting data (records) within a single node (computer) and requires a lot of time for a case of sorting data stored in a plurality of nodes in a distributed manner. This is because, generally speaking, referring to data among nodes requires a time that is hundreds of times longer than referring to data within a single node. A similar situation occurs also for a case of searching or calculating a total of data stored in a plurality of nodes in a distributed manner.

The present invention has been devised in consideration of this point and an object is to implement high-speed sorting, searching, or calculating a total of data stored in a plurality of nodes in a distributed manner.

### Solution to Problem

In order to achieve the object, a data processing system according to the present invention includes a plurality of nodes that include tables, respectively, each of the tables storing one or more records. Each of the nodes includes processing circuitry configured to: generate, from a table of the tables stored by the own node, a right structure that is used as a referred-side structure in a predetermined L-operation; generate, from the right structure, a left structure that is used as an operated-side structure in an L-operation; transmit the right structure generated by the processing circuitry to another node; receive a right structure generated by another node; perform an L-operation between the left structure and each of the right structure generated by the processing circuitry and the right structure received by the processing circuitry, and determine, for the one or more records stored by the table stored by the own node, corresponding positions in an order of all records stored by the tables that are stored by the plurality of nodes, respectively.

### Advantageous Effects of the Invention

It is possible to implement high-speed sorting, searching, or calculating a total of data stored in a plurality of nodes in a distributed manner.

### BRIEF DESCRIPTION OF THE DRAWINGS

FIG. 1A illustrates one example of a conventional art.

FIG. 1B illustrates one example of a conventional art.

FIG. 2 illustrates one example of a conventional art.

FIG. 3 illustrates examples of a left structure and a right structure.

FIG. 4 illustrates one example of an L-operation (a key comparing condition “>”).

FIG. 5 illustrates one example of an L-operation (a key comparing condition “=”).

FIG. 6 illustrates an example of relationships between a complete table and partial tables stored by respective nodes.

FIG. 7 illustrates one example of an overall configuration of a data processing system according to one embodiment of the present invention.

FIG. 8 illustrates one example of a hardware configuration of a data processing apparatus according to the embodiment of the present invention.

FIG. 9 illustrates one example of a functional configuration of the data processing apparatus according to the embodiment of the present invention.

FIG. 10 illustrates actual examples of the complete table and the partial tables stored by the respective nodes.

FIG. 11A illustrates one example of search.

FIG. 11B illustrates one example of search.

FIG. 12 illustrates one example of search.

FIG. 13 illustrates one example of search.

FIG. 14 illustrates one example of search.

FIG. 15 illustrates one example of calculating a total.

FIG. 16 illustrates one example of calculating a total.

FIG. 17A illustrates one example of single-item sorting.

FIG. 17B illustrates one example of single-item sorting.

FIG. 18A illustrates one example of single-item sorting.

FIG. 18B illustrates one example of single-item sorting.

FIG. 18C illustrates one example of single-item sorting.

FIG. 19A illustrates one example of single-item sorting.

FIG. 19B illustrates one example of single-item sorting.

FIG. 19C illustrates one example of single-item sorting.

FIG. 20A illustrates one example of single-item sorting.

FIG. 20B illustrates one example of single-item sorting.

FIG. 20C illustrates one example of single-item sorting.

FIG. 21A illustrates one example of multi-item sorting.

FIG. 21B illustrates one example of multi-item sorting.

FIG. 22 illustrates examples of subsets.

FIG. 23A illustrates one example of sorting of a subset.

FIG. 23B illustrates one example of sorting of a subset.

FIG. 24A illustrates one example of sorting of a subset.

FIG. 24B illustrates one example of sorting of a subset.

FIG. 24C illustrates one example of sorting of a subset.

FIG. 25A illustrates one example of sorting of a subset.

FIG. 25B illustrates one example of sorting of a subset.

FIG. 25C illustrates one example of sorting of a subset.

FIG. 26A illustrates one example of sorting of a subset.

FIG. 26B illustrates one example of sorting of a subset.

FIG. 26C illustrates one example of sorting of a subset.

FIG. 27 illustrates one example of splitting of a right structure.

FIG. 28A illustrates improving efficiency for an operation to compare a left structure with a split right structure.

FIG. 28B illustrates improving efficiency for an operation to compare a left structure with a split right structure.

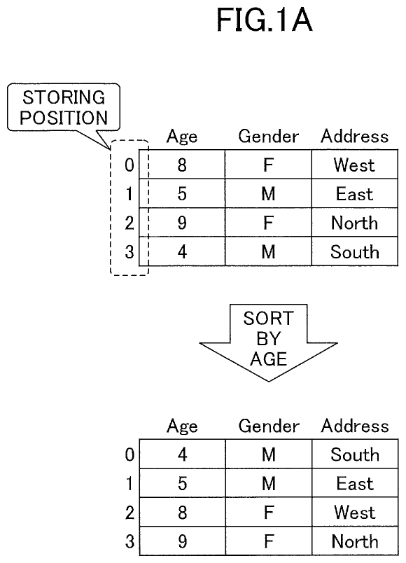

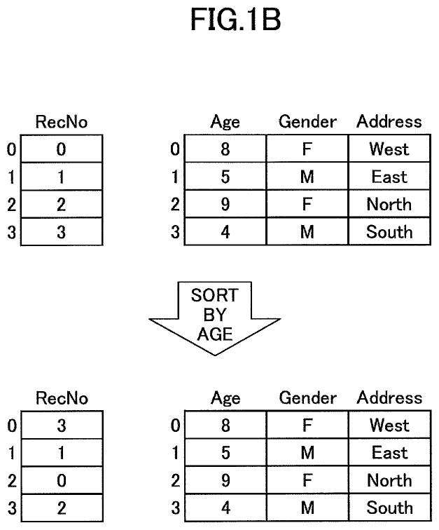

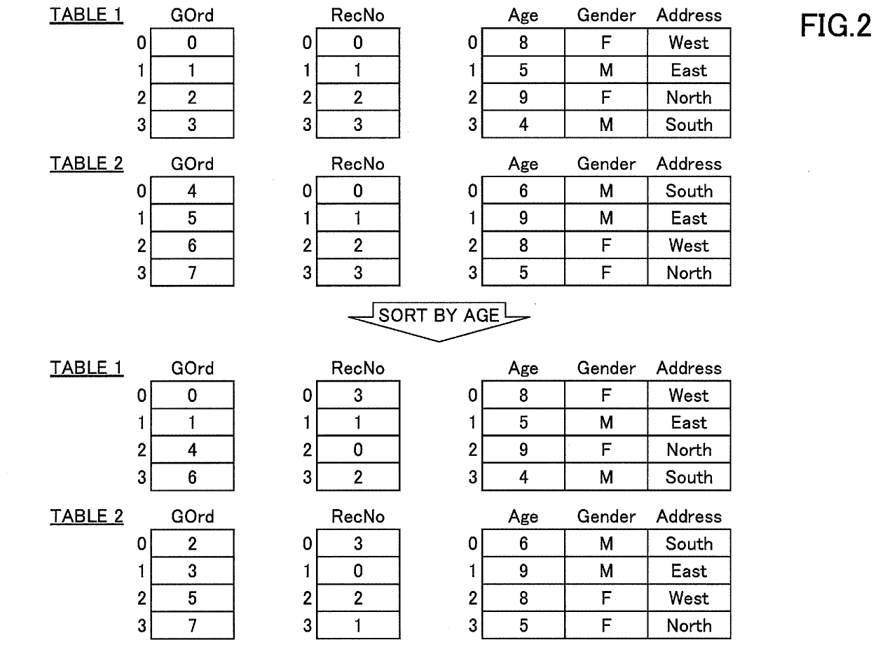

### DETAILED DESCRIPTION OF THE PREFERRED EMBODIMENTS

Below, an embodiment of the present invention will be described in detail with reference to the drawings. Concerning the embodiment of the present invention, a case where the above-described third method is expanded for sorting among a plurality of nodes to implement high-speed sorting of records stored in respective tables stored by the plurality of nodes will be described. Thus, it is possible to implement high-speed sorting of data stored in a plurality of nodes in a distributed manner. Note that, as a result of sorting being thus able to be implemented, also calculating a total, searching, JOIN, and so forth are enabled. Hereinafter, sorting, calculating a total, searching, JOIN, or the like will be also referred to as “data processing”.

<L-Operation>

First, an L-operation (Ladder Operation) for implementing data processing of various types such as sorting will now be defined. An L-operation is defined between two structures having mutually comparable ascending-order key columns. One of these two structures is an operated-side structure (hereinafter, referred to as a “left structure”) and the other is a referred-side structure (hereinafter, referred to as a “right structure”).

An L-operation means a process or an operation of comparing a key in an ascending-order key column of a left structure with a key in an ascending-order key column of a right structure with a key comparing condition (either one of “>” and “=”) to determine an operating position in the left structure, and then, storing at the operating position a result of one of various types of operations (for example, setting or resetting a flag, adding, and so forth).

An ascending-order key column may be a column of keys each including a plurality of mutually connected values, a column of keys each expressing a set of a plurality of values, or the like. In a case where a value such as a character string taking time to handle is used as a key, such a value (for example, a character string) can be indicated by an integer so as to increase the processing speed of, to simplify the process of an L-operation, or the like. In addition, as a result of thus changing a value to an integer, it is possible to implement descending-order sorting with the use of an L-operation in the same way as ascending-order sorting implemented with the use of an L-operation, through, for example, sign inversion. In this regard, descending-order sorting can be implemented by, more commonly, changing the order of the keys of a right structure and a left structure to a descending order and using “<” as a key comparing condition instead of “>”, without changing a value to an integer. Hereinafter, ascending-order sorting will be simply referred to as “sorting”.

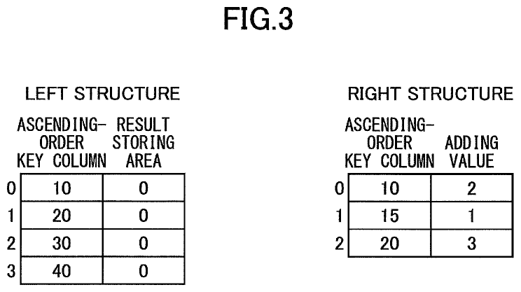

Below, an example of an actual L-operation will be described with the use of a left structure and a right structure illustrated in FIG. 3. The left structure illustrated in FIG. 3 is a 4-row structure; an ascending-order key column includes “10”, “20”, “30”, and “40”; and these keys are associated with “0”-initialized result storing areas (i.e., areas storing results of one of various types of operations). The right structure illustrated in FIG. 3 is a 3-row structure; an ascending-order key column includes “10”, “15”, and “20”; and these keys are associated with adding values “2”, “1”, and “3”.

(L-Operation (Key Comparing Condition “>”))

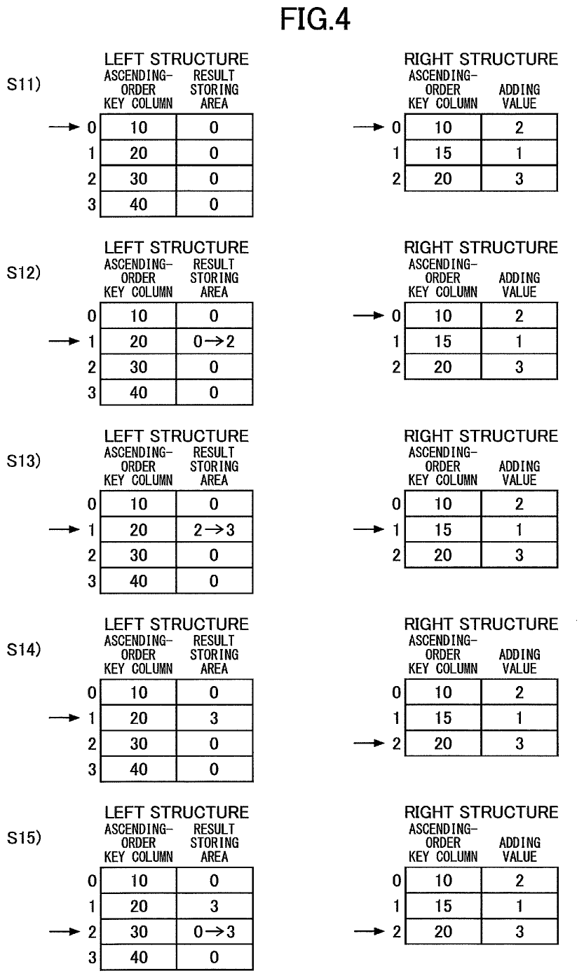

First, with reference to FIG. 4, an L-operation with a key comparing condition “>” will be described. FIG. 4 illustrates an example of an L-operation (a key comparing condition “>”).

S11) First, because an operating position in the left structure is “0” and a reference position in the right structure is “0”, the key “10” in the ascending-order key column of the left structure is compared with the key “10” in the ascending-order key column of the right structure. In this case, the key comparing condition “>” is not satisfied. As a result, the operating position in the left structure is lowered by one. The operating position in the left structure is thus updated from “0” to “1”.

S12) Next, the key “20” in the ascending-order key column of the left structure is compared with the key “10” in the ascending-order key column of the right structure. In this case, the key comparing condition “>” is satisfied. Therefore, the adding value “2” corresponding to the key “10” of the right structure is added to the result storing area corresponding to the key “20” of the left structure, and then, the reference position in the right structure is lowered by one. Thus, the value stored in the result storing area at the operating position “1” in the left structure is updated from “0” to “2” and the reference position in the right structure is updated from “0” to “1”.

S13) Next, the key “20” in the ascending-order key column of the left structure is compared with the key “15” in the ascending-order key column of the right structure. In this case, the key comparing condition “>” is satisfied. Therefore, the adding value “1” corresponding to the key “15” of the right structure is added to the result storing area corresponding to the key “20” of the left structure, and then, the reference position in the right structure is lowered by one. Thus, the value stored in the result storing area at the operating position “1” in the left structure is updated from “2” to “3” and the reference position in the right structure is updated from “1” to “2”.

S14) Next, the key “20” in the ascending-order key column of the left structure is compared with the key “20” in the ascending-order key column of the right structure. In this case, the key comparing condition “>” is not satisfied. As a result, the operating position in the left structure is lowered by one. The operating position in the left structure is thus updated from “1” to “2”.

S15) Next, the key “30” in the ascending-order key column of the left structure is compared with the key “20” in the ascending-order key column of the right structure. In this case, the key comparing condition “>” is satisfied. Therefore, the adding value “3” corresponding to the key “20” of the right structure is added to the result storing area corresponding to the key “30” of the left structure. In this regard, the current reference position in the right structure is “2” and therefore, it is not possible to further lower the reference position. Therefore, the L-operation ends. Thus, the value stored in the result storing area at the operating position “2” in the left structure is updated from “0” to “3”, and then, the L-operation ends.

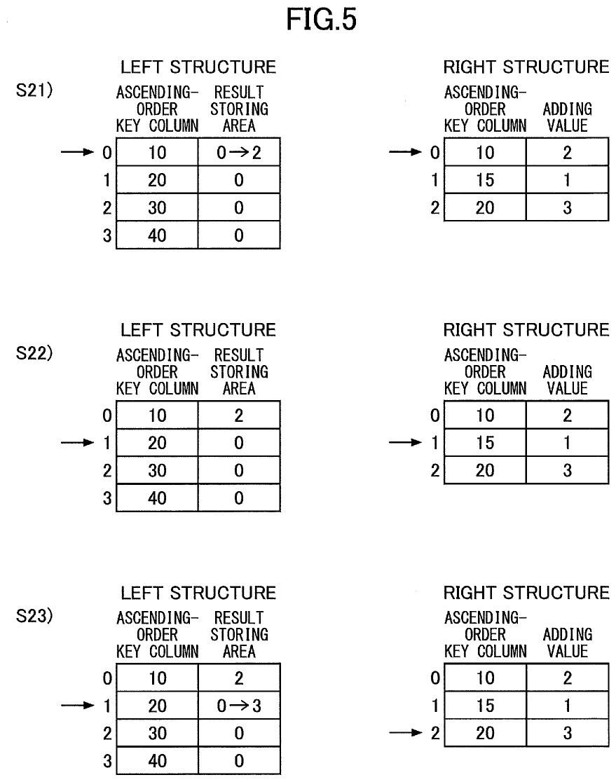

(L-operation (key comparing condition “=”)) Next, an L-operation with a key comparing condition “=” will now be described with reference to FIG. 5. FIG. 5 illustrates an example of an L-operation (a key comparing condition “=”).

S21) First, because the operating position in the left structure is “0” and the reference position in the right structure is “0”, the key “10” in the ascending-order key column of the left structure is compared with the key “10” in the ascending-order key column of the right structure. In this case, the key comparing condition “=” is satisfied. Therefore, the adding value “2” corresponding to the key “10” of the right structure is added to the result storing area corresponding to the key “10” of the left structure, and then, each of the reference position in the right structure and the operating position in the left structure is lowered by one. Thus, the value stored in the result storing area at the operating position “0” in the left structure is updated from “0” to “2”, the reference position in the right structure is updated from “0” to “1”, and the operating position in the left structure is updated from “0” to “1”.

S22) Next, the key “20” in the ascending-order key column of the left structure is compared with the key “15” in the ascending-order key column of the right structure. In this case, the key comparing condition “=” is not satisfied. Therefore, the position (the operating position or the reference position) in the structure having the smaller key value between the key “20” in the left structure and the key “15” in the right structure is lowered by one. In the example of FIG. 5, the key “15” in the right structure is smaller. Therefore, the reference position in the right structure is lowered by one. Thus, the reference position in the right structure is updated from “1” to “2”.

S23) Next, the key “20” in the ascending-order key column of the left structure is compared with the key “20” in the ascending-order key column of the right structure. In this case, the key comparing condition “=” is satisfied. Therefore, the adding value “3” corresponding to the key “20” of the right structure is added to the result storing area corresponding to the key “20” of the left structure. In this regard, the current reference position in the right structure is “2” and therefore, it is not possible to further lower the reference position. Therefore, the L-operation ends. Thus, the value stored in the result storing area at the operating position “2” in the left structure is updated from “0” to “3”, and then, the L-operation ends.

(Property of L-Operation)

From the above-described definition, it is seen that an L-operation has the following properties (1) and (2).

In a case where a left structure includes m rows and a right structure includes n rows, (1) the number of times of comparing with key comparing conditions is smaller than or equal to m+n; (2) the number of times of storing, at operating positions, results of one of various types of operations is smaller than or equal to n.

Hereinafter, assuming that key columns of a right structure and a left structure have ascending orders, an ascending-order key column will also be simply referred to as a “key column”.

<Global L-Operation>

It will be assumed that K ordered nodes are provided and the K nodes are mutually communicatively connected through a certain path (network).

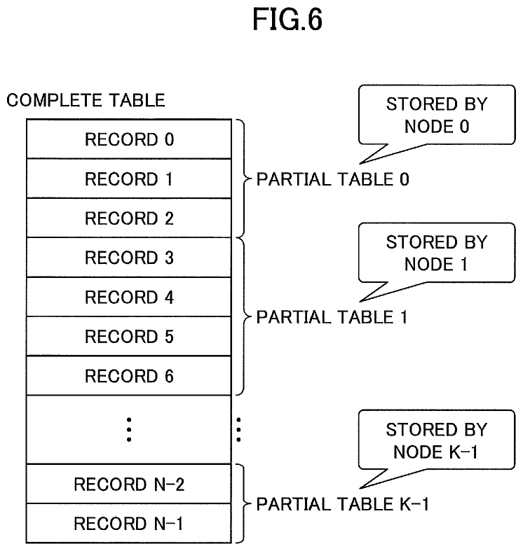

In addition, it will be assumed that a table (also referred to as a “complete table”) is provided; the complete table is split to K splits in the order from the top; and each node stores a split table (also referred to as a “partial table”) corresponding to the number (hereinafter, also referred to as a “node number”) of the node. That is, as illustrated in FIG. 6, it will be assumed that a complete table including N records is provided; for a case where the complete table is split into, in the order from the top, a partial table 0, a partial table 1, . . . , and a partial table K−1, the partial table 0 is stored by the node 0, the partial table 1 is stored by the node 1, . . . , the partial table K−1 is stored by the node K−1 (i.e., the partial table k is stored by the node k) where a node k (0≤k≤K−1) denotes the k-th node. Hereinafter, in a case where a complete table is split in the order from the top, a condition that each node stores a partial table k corresponding to the own node number k is referred to as a “stability condition”.

In this regard, an operation of mutually exchanging right structures among the K nodes and performing K L-operations (including an L-operation with the right structure of the own node) in each node will be referred to as a “Global L-operation”.

A Global L-operation has the following three features.

(Feature 1) Feature Concerning Non-Order of Operations

K L-operations in each node in any operation order have the same final result.

Thanks to the feature 1, it is possible to easily implement task switching even for a system such as a supercomputer including many nodes, for example. That is, thanks to the feature concerning non-order of operations of a Global L-operation, even if different tasks have been executed in nodes, each node can obtain a proper operation result by performing an L-operation after finishing a task. Therefore, task switching is easily implemented.

(Feature 2) Feature Concerning Parallel Processing of Operations

K L-operations in each node can be executed in parallel. This is because L-operations are independent from each other.

(Feature 3) Applicability to Various Distributed Architectures:

A Global L-operation only requires that respective nodes are ordered and each node stores a partial table corresponding to the own node number; a Global L-operation can be implemented without regard to a topology in which respective nodes are mutually connected.

<Overall Configuration of Data Processing System 1>

Below, a data processing system 1 in which it is possible to implement data processing that may be sorting (for example, sorting, calculating a total, searching, JOIN, or the like) through a Global L-operation described above will be described.

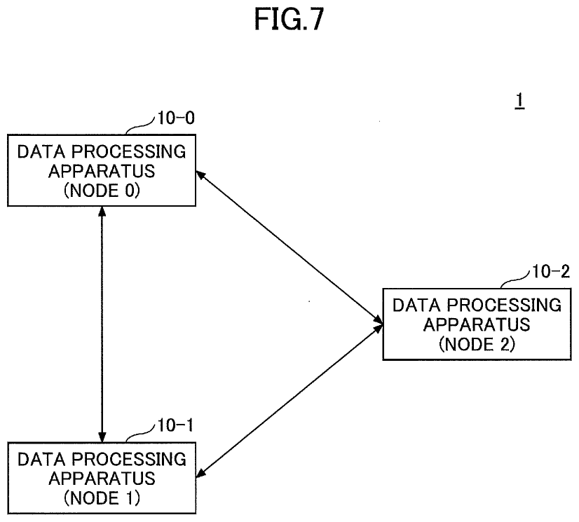

First, an overall configuration of a data processing system 1 according to an embodiment of the present invention will be described with reference to FIG. 7. FIG. 7 illustrates one example of an overall configuration of a data processing system 1 according to an embodiment of the present invention.

As illustrated in FIG. 7, a data processing system 1 according to an embodiment of the present invention includes K data processing apparatuses 10; the data processing apparatuses 10 are mutually connected communicatively via a predetermined network.

Each data processing apparatus 10 is a computer acting as an above-described node. That is, the respective data processing apparatuses 10 are ordered and store partial tables corresponding to the own node numbers.

Below, for example, K=3 is assumed; the data processing apparatuses 10 included in the data processing system 1 will also be referred to as a “data processing apparatus 10-0”, a “data processing apparatus 10-1”, and a “data processing apparatus 10-2”; the data processing apparatus 10-0 has a node number “0”, the data processing apparatus 10-1 has a node number “1”, and the data processing apparatus 10-2 has a node number “2”. The node having the node number 0 is also referred to as a “node 0”, the node having the node number 1 is also referred to as a “node 1”, and the node having the node number 2 is also referred to as a “node 2”.

The data processing system 1 illustrated in FIG. 7 is one example, and may have another configuration. For example, it is also possible that K is 2 or more and the data processing system 1 includes K data processing apparatuses 10 where K is any number. For example, in a case where a data processing system 1 is a supercomputer, generally speaking, K may be on the order of tens of thousands.

<Hardware Configuration of Data Processing Apparatus 10>

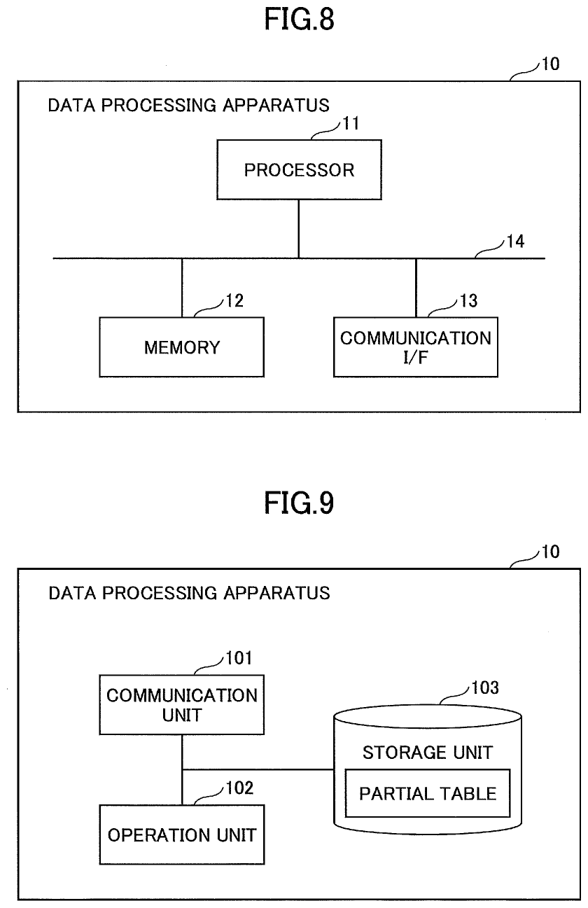

Next, a hardware configuration of a data processing apparatus 10 according to the embodiment of the present invention will be described with reference to FIG. 8. FIG. 8 illustrates an example of a hardware configuration of a data processing apparatus 10 according to the embodiment of the present invention.

As illustrated in FIG. 8, a data processing apparatus 10 according to the embodiment of the present invention includes, as hardware, a processor 11, a memory 12, and a communication I/F 13. These hardware units are connected together communicatively via a bus 14.

The processor 11 is, for example, a CPU (Central Processing Unit) or the like and is an operation unit executing various processes. The memory 12 is, for example, a RAM (Random Access Memory), a ROM (Read-Only Memory), an auxiliary storage unit, or the like and stores various programs and data. The communication I/F 13 is an interface for connecting the data processing apparatus 10 with a network.

A data processing apparatus 10 according to the embodiment of the present invention includes the hardware illustrated in FIG. 8 to implement data processing such as sorting. A data processing apparatus 10 according to the embodiment of the present invention may further include, in addition to the hardware illustrated in FIG. 8, an input device such as a keyboard and a mouse, a display device such as a display, and so forth.

<Functional Configuration of Data Processing Apparatus 10>

Next, a functional configuration of a data processing apparatus 10 according to the embodiment of the present invention will be described with reference to FIG. 9. FIG. 9 illustrates an example of a functional configuration of a data processing apparatus 10 according to the embodiment of the present invention.

As illustrated in FIG. 9, a data processing apparatus 10 according to the embodiment of the present invention includes, as functional units, a communication unit 101 and an operation unit 102. These functional units are implemented by processing executed by the processor 11 according to one or more programs installed in the data processing apparatus 10.

A data processing apparatus 10 according to the embodiment of the present invention further includes a storage unit 103. The storage unit 103 can be implemented with the use of the memory 12 or the like, for example.

The storage unit 103 stores a partial table corresponding to a node number of the own node. The communication unit 101 transmits data to and receives data from another node (i.e., transmits a right structure of the own node and receives a right structure from another node). The operation unit 102 generates a left structure and a right structure and performs various operations including L-operations. As a result of the operation unit 102 performing various operations, data processing such as sorting, calculating a total, searching, JOIN, and so forth is implemented.

<Actual Examples of Complete Table and Table of Each Node>

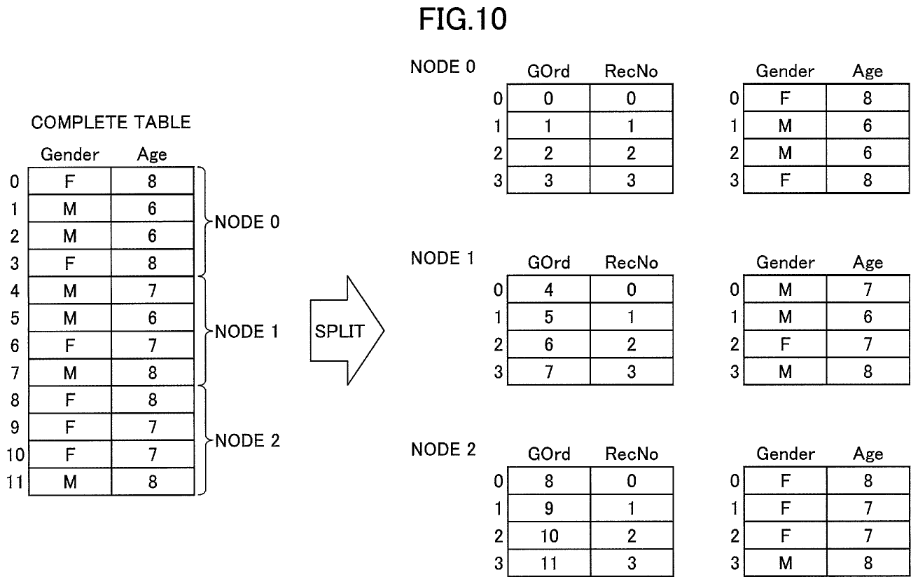

Next, actual examples of a complete table and respective partial tables stored by the nodes 1-3 will be described with reference to FIG. 10. FIG. 10 illustrates actual examples of a complete table and a partial table stored by each node.

As illustrated in FIG. 10, the complete table stores 12 records including data items “gender” and “age”.

In this regard, from among the records stored in the complete table, a partial table including the records stored at the storing positions “0”-“3” is assumed to be stored by the node 0. Similarly, a partial table including the records stored at the storing positions “4”-“7” is assumed to be stored by the node 1. Similarly, a partial table including the records stored at the storing positions “8”-“11” is assumed to be stored by the node 2.

The partial table that each node stores is associated with a GOrd list storing GOrd values indicating a global order among the partial tables and a record number list storing record numbers (RecNos) indicating the order of the records in the partial table. In this regard, it is assumed that, immediately after the partial tables are split from the complete table, the GOrd values have an ascending order among the partial tables when the partial tables are arranged in an ascending order of the node numbers; and the RecNo values have an ascending order in one partial table.

Below, each data processing will be described assuming that, in each of searching, calculating a total, single-item sorting, and multi-item sorting, the nodes 1-3 store the partial tables illustrated in FIG. 10, respectively (that is, a partial table satisfying a stability condition is stored in the storage unit 103).

<Search>

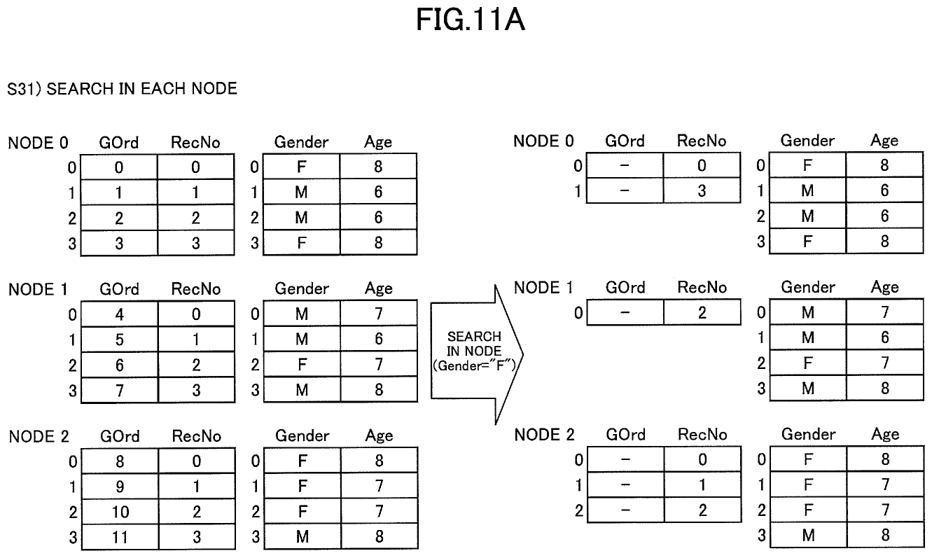

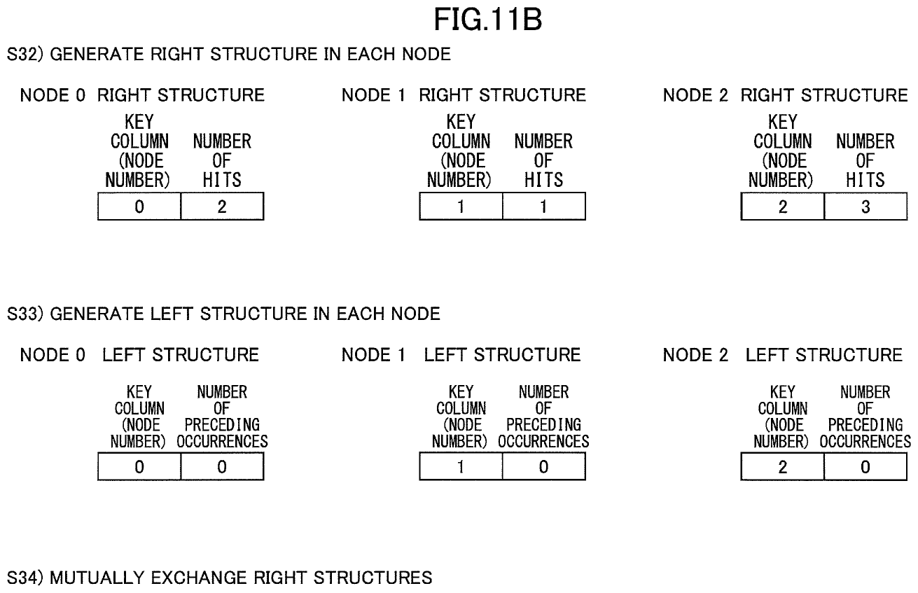

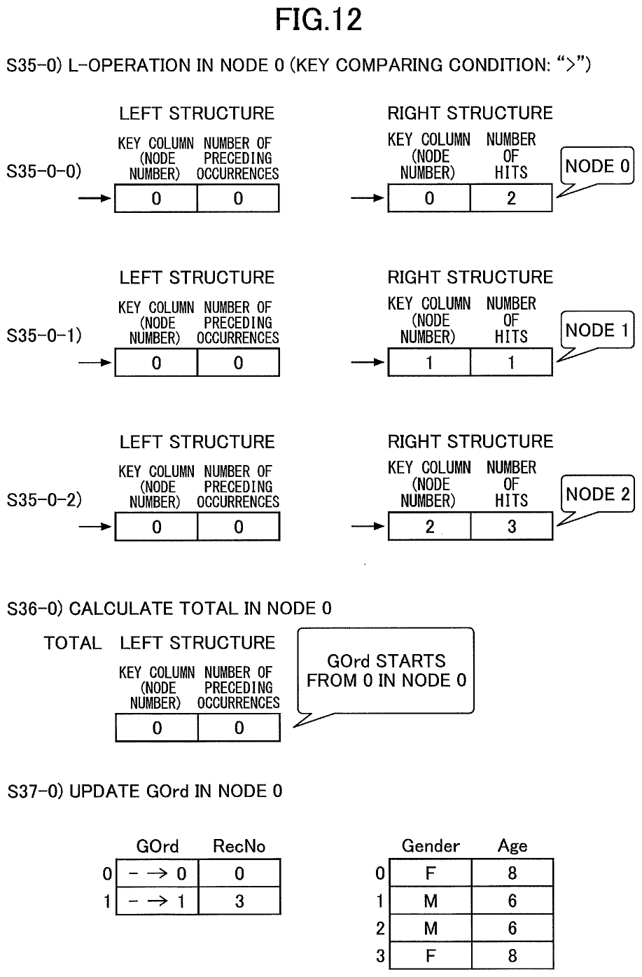

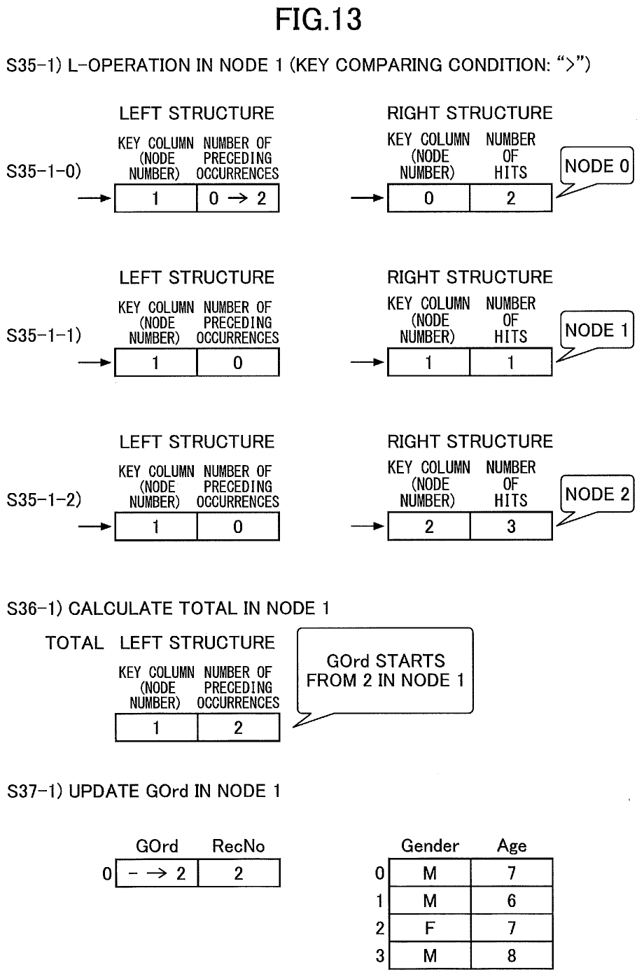

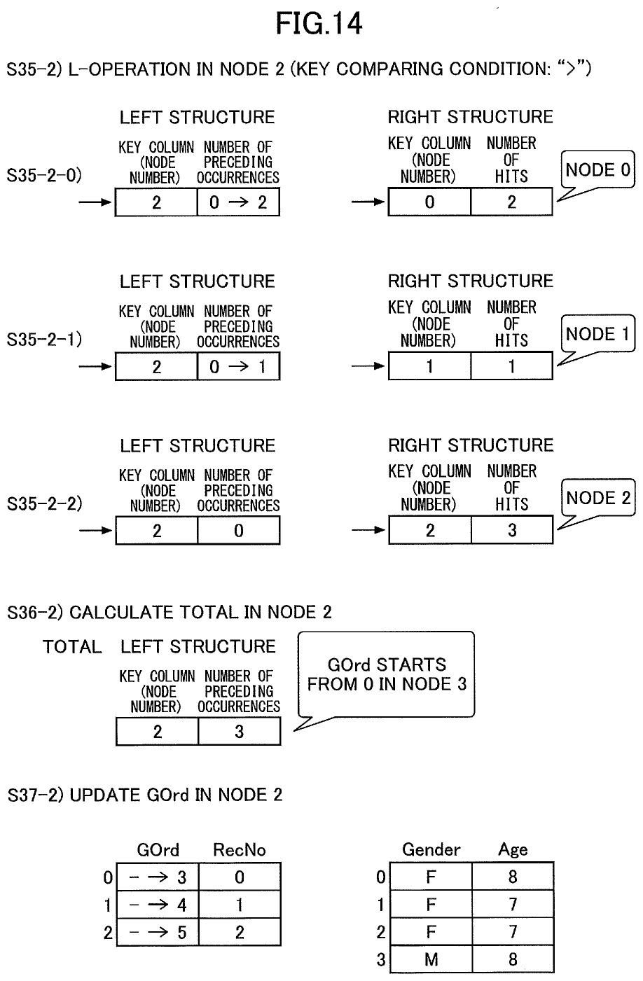

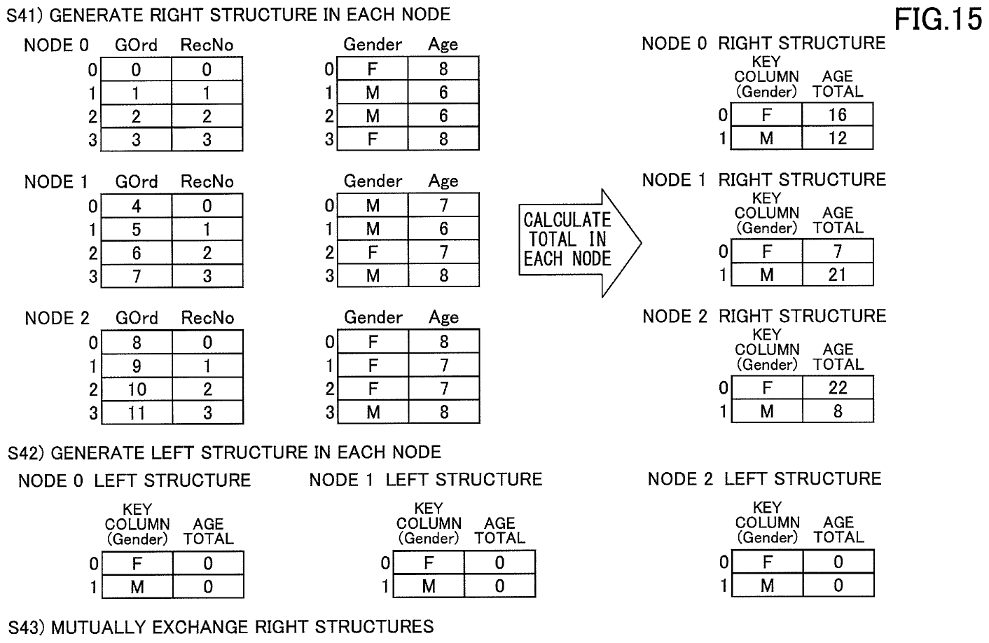

First, as one example of data processing, a case of searching for records having gender=“F” will be described with reference to FIGS. 11-14. FIGS. 11-14 illustrate one example of a search.

S31) First, the operation unit 102 of each data processing apparatus 10 searches for records having gender=“F” in the own apparatus 10. That is, the operation unit 102 of each data processing apparatus 10 searches the partial table stored in the own storage unit 103 for records having gender=“F”.

Then, the operation unit 102 of each data processing apparatus 10 generates a record number list storing the record numbers of the records obtained from the search and a GOrd list storing null values.

Thus, in the data processing apparatus 10-0 (node 0), a record list storing the record numbers “0” and “3” and a GOrd list storing the null values for these record numbers are generated. Similarly, in the data processing apparatus 10-1 (the node 1), a record list storing the record number “2” and a GOrd list storing the null value for this record number are generated. Similarly, in the data processing apparatus 10-2 (the node 2), a record list storing the record numbers “0”, “1”, and “2” and a GOrd list storing the null values for these record numbers are generated.

S32) Next, the operation unit 102 of each data processing apparatus 10 generates a right structure. That is, the operation unit 102 of each data processing apparatus 10 generates a right structure where the node number of the own node is stored as a “key column” and the number of records obtained from the search of S31 is stored as a “number of hits”. Thus, in the data processing apparatus 10-0 (the node 0), a right structure having 1 row where the key “0” and the number of hits “2” are associated with each other is generated. Similarly, in the data processing apparatus 10-1 (the node 1), a right structure having 1 row where the key “1” and the number of hits “1” are associated with each other is generated. Similarly, in the data processing apparatus 10-2 (the node 2), a right structure having 1 row where the key “2” and the number of hits “3” are associated with each other is generated.

S33) Next, the operation unit 102 of each data processing apparatus 10 generates a left structure. That is, the operation unit 102 of each data processing apparatus 10 generates a left structure where the node number of the own node is stored at a “key column” and an initial value “0” is stored as the “number of preceding occurrences”. Note that the number of preceding occurrences indicates a result storing area for storing the number of records obtained from searches at the nodes having the node numbers smaller than that of the own node.

Thus, in the data processing apparatus 10-0 (the node 0), a left structure having 1 row where a key “0” is associated with the number of preceding occurrences “2” is generated. Similarly, in the data processing apparatus 10-1 (the node 1), a left structure having 1 row where a key “1” is associated with the number of preceding occurrences “0” is generated. Similarly, in the data processing apparatus 10-2 (the node 2), a left structure having 1 row where a key “2” is associated with the number of preceding occurrences “0” is generated.

S34) Next, the communication unit 101 of each data processing apparatus 10 mutually exchanges the right structures generated in S32. That is, the communication unit 101 of each data processing apparatus 10 transmits the right structure of the own node to all the other nodes and receives the right structures transmitted from all of the other nodes. Note that S34 may be executed immediately after S32.

The following S35-0 through S37-0 are executed in the node 0, S35-1 through S37-1 are executed in the node 1, and S35-2 through S37-2 are executed in the node 2. In this regard, each node may execute these processes independently. This is because a Global L-operation has the above-mentioned feature 2.

S35-0) The operation unit 102 of the data processing apparatus 10-0 performs an L-operation with a key comparing condition “>”. In detail, the operation unit 102 of the data processing apparatus 10-0 executes the following S35-0-0 through S35-0-2. In this regard, in some cases, for parallel processing of S35-0-0 through S35-0-2 described below, the operation unit 102 of the data processing apparatus 10-0 uses the numbers of preceding occurrences included in the left structure in the left structures stored in different storage areas, respectively. In other words, in some cases, for parallel processing, the operation unit 102 of the data processing apparatus 10-0 uses the number of preceding occurrences included in the left structure that is for comparison with the right structure of the node 0, the number of preceding occurrences included in the left structure that is for comparison with the right structure of the node 1, and the number of preceding occurrences included in the left structure that is for comparison with the right structure of the node 2. Note that because a Global L-operation has the above-described feature 1, the following S35-0-0 through S35-0-2 may be executed in any order.

S35-0-0) The operation unit 102 of the data processing apparatus 10-0 compares the key “0” at the key column of the left structure of the own node (the node 0) with the key “0” at the key column of the right structure of the own node (the node 0). In this case, the key comparing condition “>” is not satisfied. As a result, the operation unit 102 would lower the operating position in the left structure by one. However, because it is not possible to further lower the operating position, the operation unit 102 ends the L-operation.

S35-0-1) The operation unit 102 of the data processing apparatus 10-0 compares the key “0” at the key column of the left structure of the own node with the key “1” at the key column of the right structure of the node 1. In this case, the key comparing condition “>” is not satisfied. Therefore, the operation unit 102 would lower the operating position in the left structure by one. However, it is not possible to further lower the operating position. Therefore, the operation unit 102 ends the L-operation.

S35-0-2) The operation unit 102 of the data processing apparatus 10-0 compares the key “0” at the key column of the left structure of the own node with the key “2” at the key column of the right structure of the node 2. In this case, the key comparing condition “>” is not satisfied. Therefore, the operation unit 102 would lower the operating position in the left structure by one. However, it is not possible to further lower the operating position. Therefore, the operation unit 102 ends the L-operation.

S36-0) Next, the operation unit 102 of the data processing apparatus 10-0 calculates a total of the numbers of preceding occurrences of the left structures. That is, the operation unit 102 of the data processing apparatus 10-0 calculates a total of the respective numbers of preceding occurrences of the left structure that is for comparison with the right structure of the node 0, of the left structure that is for comparison with the right structure of the node 1, and of the left structure that is for comparison with the right structure of the node 2. This total will be used as a start number of a GOrd value in the node 0. In this case, because the total of the numbers of preceding occurrences is “0”, the start number of a GOrd value in the node 0 is “0”.

S37-0) Next, the operation unit 102 of the data processing apparatus 10-0 uses the start number of a GOrd value of the own node and updates the GOrd list of the own node generated in S31. That is, the operation unit 102 of the data processing apparatus 10-0 stores, in the GOrd list, values that start from the start number and that are incremented from the top place, one by one. Thus, in the GOrd list of the node 0, a GOrd value “0” is stored at the storing position “0” and a GOrd value “1” is stored at the storing position “1”.

S35-1) The operation unit 102 of the data processing apparatus 10-1 performs an L-operation with a key comparing condition “>”. In detail, the operation unit 102 of the data processing apparatus 10-1 executes the following S35-1-0 through S35-1-2. In this regard, in some cases, for parallel processing of S35-1-0 through S35-1-2 described below, the operation unit 102 of the data processing apparatus 10-1 uses the numbers of preceding occurrences included in the left structures stored in different storage areas, respectively. In other words, in some cases, for parallel processing, the operation unit 102 of the data processing apparatus 10-1 uses the number of preceding occurrences included in the left structure that is for comparison with the right structure of the node 0, the number of preceding occurrences included in the left structure that is for comparison with the right structure of the node 1, and the number of preceding occurrences included in the left structure that is for comparison with the right structure of the node 2. Note that because a Global L-operation has the above-described feature 1, the following S35-1-0 through S35-1-2 may be executed in any order.

S35-1-0) The operation unit 102 of the data processing apparatus 10-1 compares the key “1” at the key column of the left structure of the own node with the key “0” at the key column of the right structure of the node 0. In this case, the key comparing condition “>” is satisfied. As a result, the operation unit 102 adds the number of hits “2” corresponding to the key “0” of the right structure to the number of preceding occurrences corresponding to the key “1” of the left structure. Then, the operation unit 102 would lower the reference position in the right structure by one. However, because it is not possible to further lower the reference position, the operation unit 102 ends the L-operation. Thus, the number of preceding occurrences of the left structure is updated from “0” to “2”.

S35-1-1) The operation unit 102 of the data processing apparatus 10-1 compares the key “1” at the key column of the left structure of the own node with the key “1” at the key column of the right structure of the own node. In this case, the key comparing condition “>” is not satisfied. As a result, the operation unit 102 would lower the operating position in the left structure by one. However, because it is not possible to further lower the operating position, the operation unit 102 ends the L-operation.

S35-1-2) The operation unit 102 of the data processing apparatus 10-1 compares the key “1” at the key column of the left structure of the own node with the key “2” at the key column of the right structure of the node 2. In this case, the key comparing condition “>” is not satisfied. As a result, the operation unit 102 would lower the reference position in the left structure by one. However, because it is not possible to further lower the reference position, the operation unit 102 ends the L-operation.

S36-1) Next, the operation unit 102 of the data processing apparatus 10-1 calculates a total of the numbers of preceding occurrences of the left structures. That is, the operation unit 102 of the data processing apparatus 10-1 calculates a total of the respective numbers of preceding occurrences of the left structure that is for comparison with the right structure of the node 0, of the left structure that is for comparison with the right structure of the node 1, and of the left structure that is for comparison with the right structure of the node 2. This total will be used as a start number of a GOrd value in the node 1. In this case, because the total of the numbers of preceding occurrences is “2”, the start number of a GOrd value in the node 1 is “2”.

S37-1) Next, the operation unit 102 of the data processing apparatus 10-1 uses the start number of a GOrd value of the own node and updates the GOrd list of the own node generated in S31. That is, the operation unit 102 of the data processing apparatus 10-1 stores, in the GOrd list, a value that starts from the start number and that is incremented from the top place, one by one. Thus, in the GOrd list of the node 1, GOrd “2” is stored at the storing position “0”.

S35-2) The operation unit 102 of the data processing apparatus 10-2 performs an L-operation with a key comparing condition “>”. In detail, the operation unit 102 of the data processing apparatus 10-2 executes the following S35-2-0 through S35-2-2. In this regard, in some cases, for parallel processing of S35-2-0 through S35-2-2 described below, the operation unit 102 of the data processing apparatus 10-1 uses the numbers of preceding occurrences included in the left structures stored in different storage areas, respectively. In other words, in some cases, for parallel processing, the operation unit 102 of the data processing apparatus 10-1 uses the number of preceding occurrences included in the left structure that is for comparison with the right structure of the node 0, the number of preceding occurrences included in the left structure that is for comparison with the right structure of the node 1, and the number of preceding occurrences included in the left structure that is for comparison with the right structure of the node 2. Note that because a Global L-operation has the above-described feature 1, the following S35-2-0 through S35-2-2 may be executed in any order.

S35-2-0) The operation unit 102 of the data processing apparatus 10-2 compares the key “2” at the key column of the left structure of the own node with the key “0” at the key column of the right structure of the node 0. In this case, the key comparing condition “>” is satisfied. As a result, the operation unit 102 adds the number of hits “2” corresponding to the key “0” of the right structure to the number of preceding occurrences corresponding to the key “2” of the left structure. Then, the operation unit 102 would lower the reference position in the right structure by one. However, because it is not possible to further lower the reference position, the operation unit 102 ends the L-operation. Thus, the number of preceding occurrences of the left structure is updated from “0” to “2”.

S35-2-1) The operation unit 102 of the data processing apparatus 10-2 compares the key “2” at the key column of the left structure of the own node with the key “1” at the key column of the right structure of the node 1. In this case, the key comparing condition “>” is satisfied. As a result, the operation unit 102 adds the number of hits “1” corresponding to the key “1” of the right structure to the number of preceding occurrences corresponding to the key “2” of the left structure. Then, the operation unit 102 would lower the reference position in the right structure by one. However, because it is not possible to further lower the reference position, the operation unit 102 ends the L-operation. Thus, the number of preceding occurrences of the left structure is updated from “0” to “1”.

35-2-2) The operation unit 102 of the data processing apparatus 10-2 compares the key “2” at the key column of the left structure of the own node with the key “2” at the key column of the right structure of the own node (the node 2). In this case, the key comparing condition “>” is not satisfied. As a result, the operation unit 102 would lower the operating position in the left structure by one. However, because it is not possible to further lower the operating position, the operation unit 102 ends the L-operation.

S36-2) Next, the operation unit 102 of the data processing apparatus 10-2 calculates a total of the numbers of preceding occurrences of the left structures. That is, the operation unit 102 of the data processing apparatus 10-2 calculates a total of the respective numbers of preceding occurrences of the left structure that is for comparison with the right structure of the node 0, of the left structure that is for comparison with the right structure of the node 1, and of the left structure that is for comparison with the right structure of the node 2. This total will be used as a start number of a GOrd value in the node 2. In this case, because the total of the numbers of preceding occurrences is “3”, the start number of a GOrd value in the node 2 is “3”.

S37-2) Next, the operation unit 102 of the data processing apparatus 10-2 uses the start number of a GOrd value of the own node and updates the GOrd list of the own node generated in S31. That is, the operation unit 102 of the data processing apparatus 10-2 stores, in the GOrd list, values that start from the start number and that are incremented from the top place, one by one. Thus, in the GOrd list of the node 2, a GOrd value “3” is stored at the storing position “0”, a GOrd value “4” is stored at the storing position “1”, and a GOrd value “5” is stored at the storing position “2”.

Thus, the GOrd values are stored in each GOrd list generated in S31. Thus, the search result where, for the records obtained from the search in each data processing apparatus 10, the GOrd values are provided.

<Total Calculation>

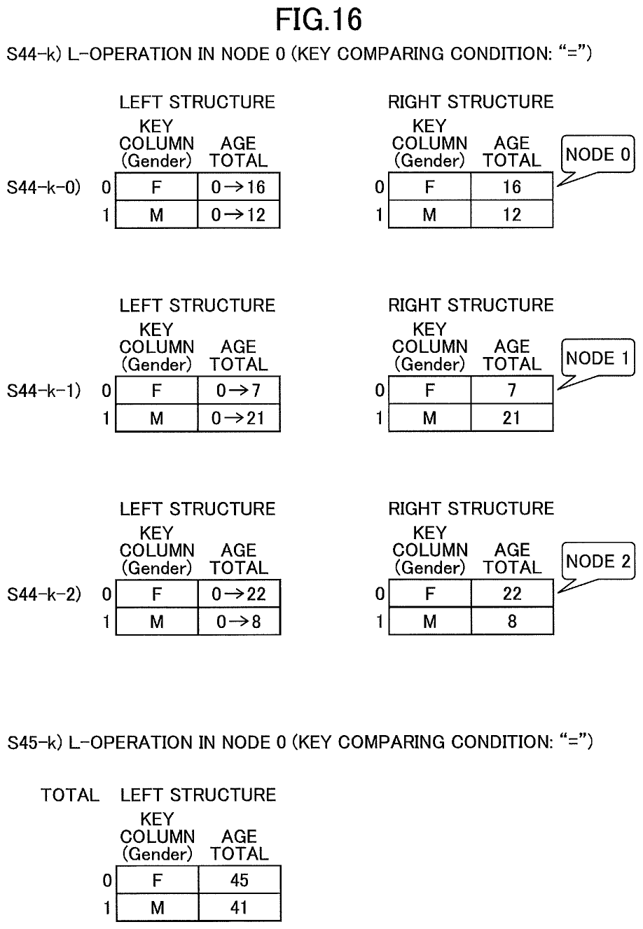

Next, as one example of data processing, a case of calculating a total of ages on a per-gender basis will be described with reference to FIGS. 15-16. FIGS. 15-16 illustrate one example of total calculation.

S41) First, the operation unit 102 of each data processing apparatus 10 calculates a total of ages in the own node on a per-gender basis and generates a right structure. That is, the operation unit 102 of each data processing apparatus 10 calculates, in the partial table stored in the own storage unit 103, a total of ages on a per-gender basis. Then, the operation unit 102 of each data processing apparatus 10 stores the genders in “key column”, the totals of ages for the genders in “age total”, and thus, generates a right structure.

Thus, in the data processing apparatus 10-0 (the node 0), a right structure including 2 rows, i.e., a row where the key “F” is associated with the age total “16” and a row where the key “M” is associated with the age total “12”, is generated. Similarly, in the data processing apparatus 10-1 (the node 1), a right structure including 2 rows, i.e., a row where the key “F” is associated with the age total “7” and a row where the key “M” is associated with the age total “21”, is generated. In the data processing apparatus 10-2 (the node 2), a right structure including 2 rows, i.e., a row where the key “F” is associated with the age total “22” and a row where the key “M” is associated with the age total “8”, is generated.

S42) Next, the operation unit 102 of each data processing apparatus 10 generates a left structure. That is, the operation unit 102 of each data processing apparatus 10 stores the genders in “key column” and initial values “0” of age totals for the genders, and thus, generates a left structure.

Thus, in the data processing apparatus 10-0 (the node 0), a right structure including 2 rows, i.e., a row where the key “F” is associated with the age total “0” and a row where the key “M” is associated with the age total “0”, is generated. Also in the data processing apparatus 10-1 (the node 1) and the data processing apparatus 10-2 (the node 2), the same 2-row right structures are generated.

S43) Next, the communication unit 101 of each data processing apparatus 10 mutually exchanges the right structures generated in S41. That is, the communication unit 101 of each data processing apparatus 10 transmits the right structure of the own node to all the other nodes and receives the right structures transmitted from all of the other nodes. Note that S43 may be executed immediately after S41.

The following S44-k through S45-k are executed in the node k, where k is substituted by 0, 1, and 2. Each node can execute these processes independently. This is because a Global L-operation has the above-mentioned feature 2.

S44-k) The operation unit 102 of the data processing apparatus 10-k (the node k) performs an L-operation with a key comparing condition “=”. In detail, the operation unit 102 of the data processing apparatus 10-k executes the following S44-k-0 through S44-k-2. In this regard, in some cases, for parallel processing of S44-k-0 through S44-k-2 described below, the operation unit 102 of the data processing apparatus 10-k uses the age totals included in the left structures stored in different storage areas, respectively. In other words, in some cases, for parallel processing, the operation unit 102 of the data processing apparatus 10-k uses the age total included in the left structure that is for comparison with the right structure of the node 0, the age total included in the left structure that is for comparison with the right structure of the node 1, and the age total included in the left structure that is for comparison with the right structure of the node 2. Note that because a Global L-operation has the above-described feature 1, the following S44-k-0 through S44-k-2 may be executed in any order.

S44-k-0) The operation unit 102 of the data processing apparatus 10-k compares the key “F” at the key column of the left structure of the own node with the key “F” at the key column of the right structure of the node 0. In this case, the key comparing condition “=” is satisfied. As a result, the operation unit 102 adds the age total “16” corresponding to the key “F” of the right structure to the age total corresponding to the key “F” of the left structure. Then, the operation unit 102 lowers the reference position in the right structure and the operating position of the left structure by one. Thus, the age total (i.e., the age total for the gender “F”) at the operating position “0” of the left structure is updated from “0” to “16”; the reference position in the right structure is updated from “0” to “1”; and the operating position in the left structure is updated from “0” to “1”.

Next, the operation unit 102 of the data processing apparatus 10-k compares the key “M” at the key column of the left structure of the own node with the key “M” at the key column of the right structure of the node 0. In this case, the key comparing condition “=” is satisfied. As a result, the operation unit 102 adds the age total “12” corresponding to the key “M” of the right structure to the age total corresponding to the key “M” the left structure. Then, the operation unit 102 would lower the reference position in the right structure and the operating position of the left structure by one. However, because it is not possible to further lower the reference position and the operating position, the operation unit 102 ends the L-operation. Thus, the age total (i.e., the age total for the gender “M”) of the left structure at the operating position “0” is updated to “12”.

S44-k-1) The operation unit 102 of the data processing apparatus 10-k performs an L-operation with the key comparing condition “=” in the same way as S44-k-0. Thus, the age total in the left structure for the gender “F” is updated to “7” and the age total in the left structure for the gender “M” is updated to “21”.

S44-k-2) The operation unit 102 of the data processing apparatus 10-k performs an L-operation with the key comparing condition “=” in the same way as S44-k-0. Thus, the age total in the left structure for the gender “F” is updated to “22” and the age total in the left structure for the gender “M” is updated to “8”.

S45-k) Next, the operation unit 102 of the data processing apparatus 10-k calculates a total of the age totals for each gender. That is, the operation unit 102 of the data processing apparatus 10-k calculates a total of the age totals for the respective genders of the left structure that is for comparison with the right structure of the node 0, of the left structure that is for comparison with the right structure of the node 1, and of the left structure that is for comparison with the right structure of the node 2. Thus, a left structure including a row where the gender “F” is associated with the age total “45” and a row where the gender “M” is associated with the age total “41” is obtained.

Thus, for each node k (k=0, 1, 2), the same total calculation results (the age totals on a per-gender basis) can be obtained.

<Single-Item Sorting>

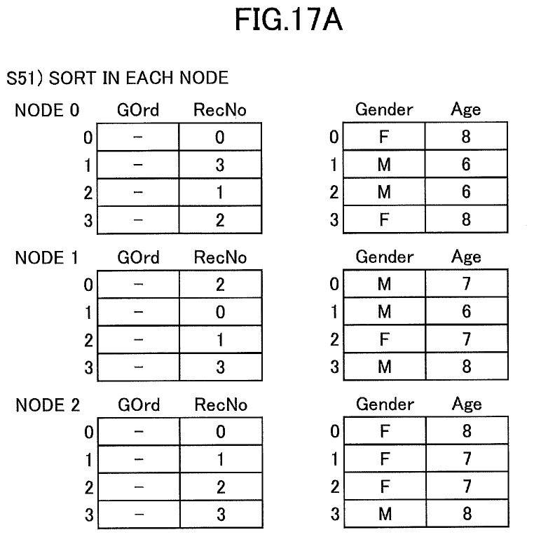

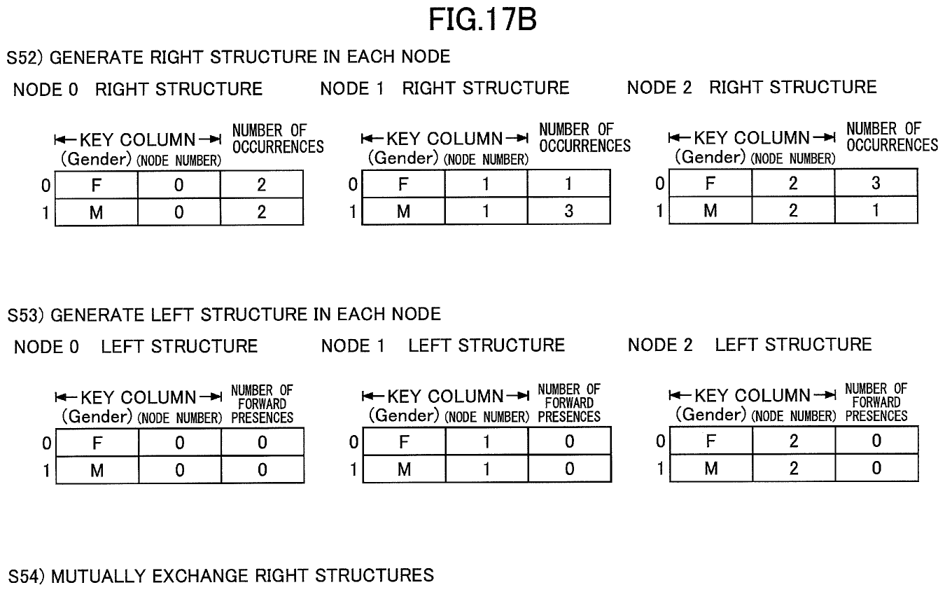

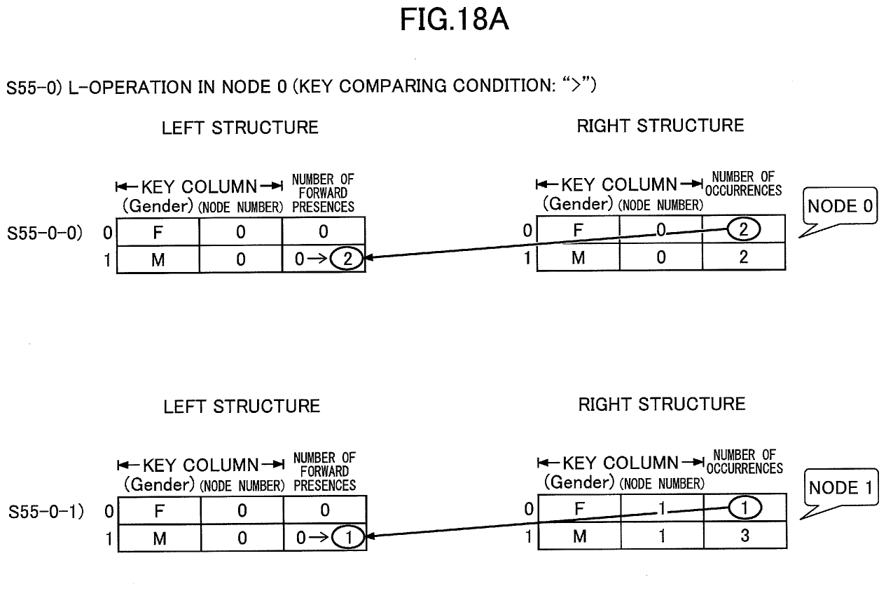

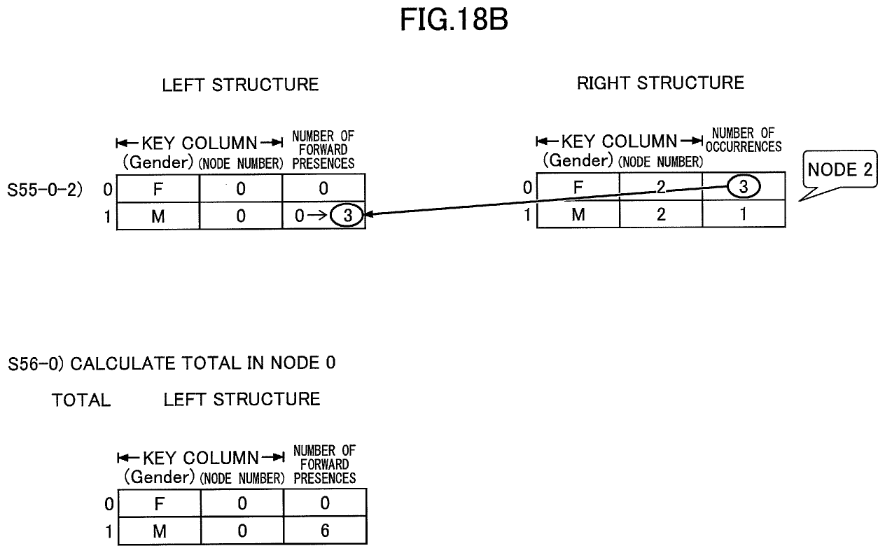

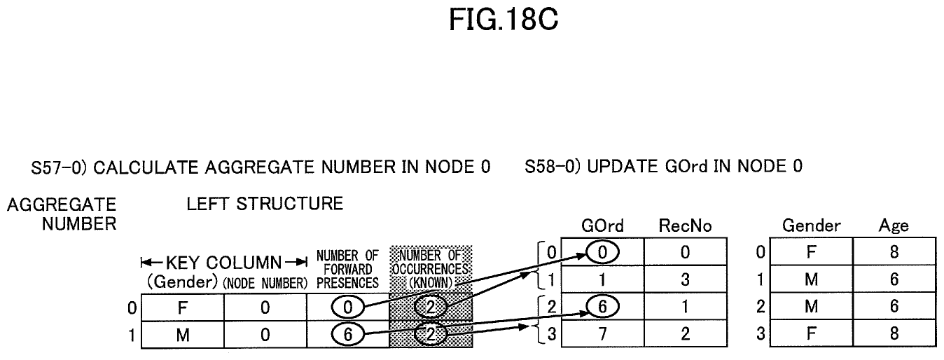

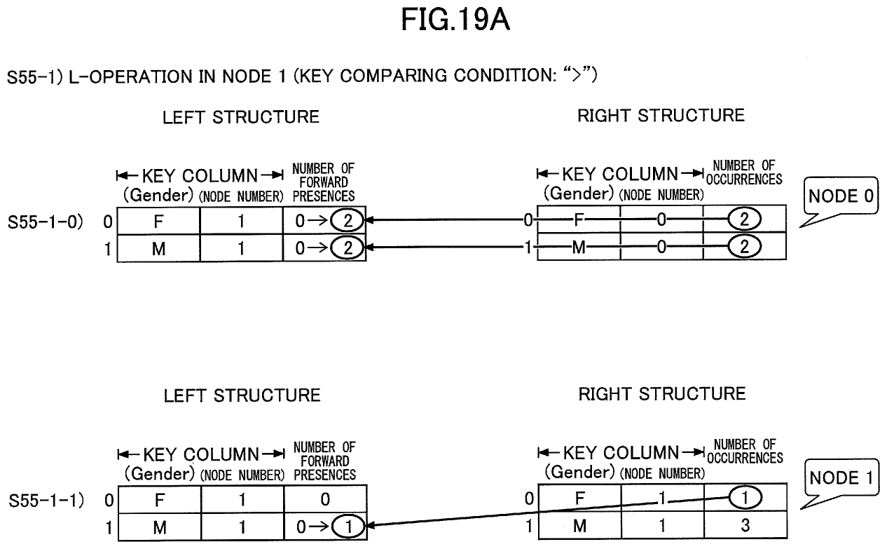

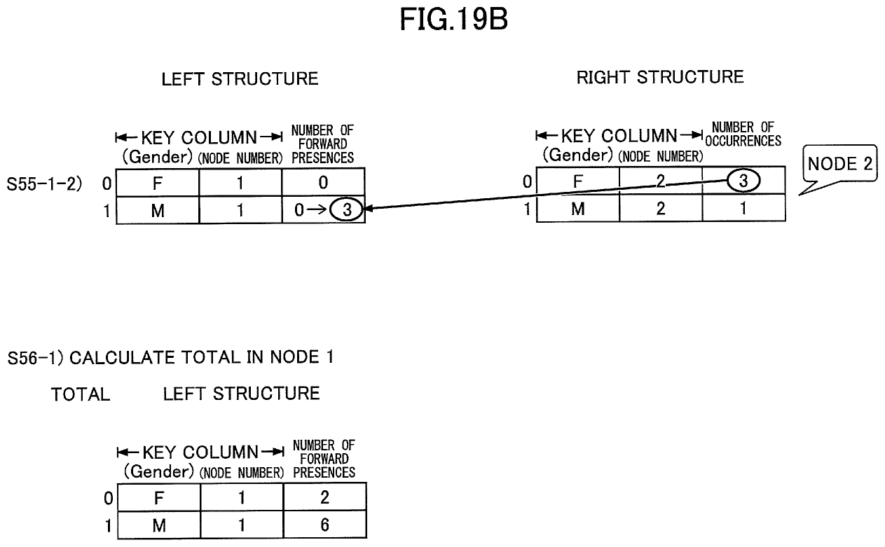

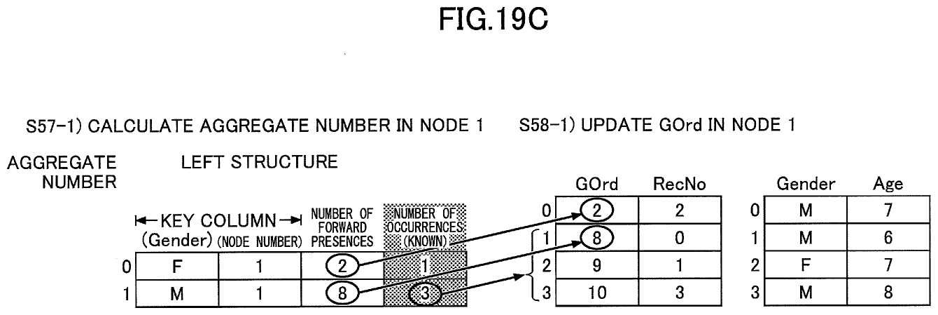

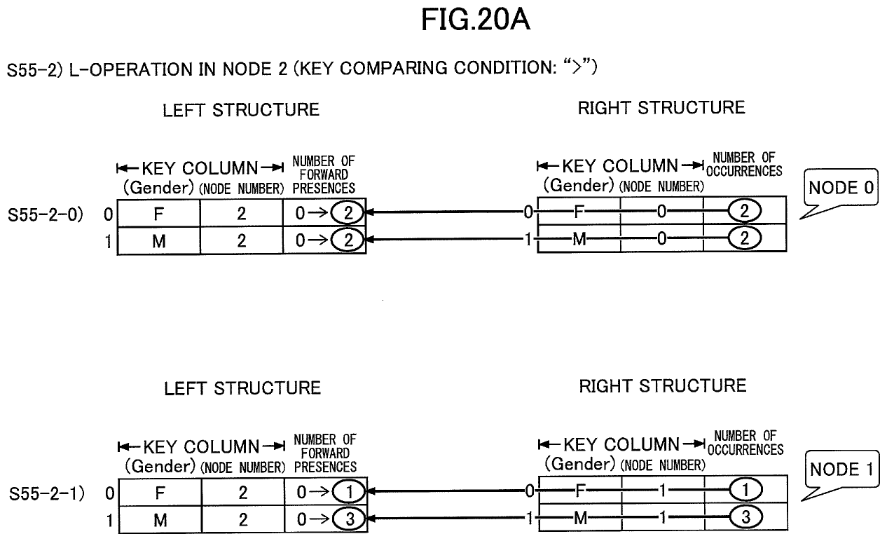

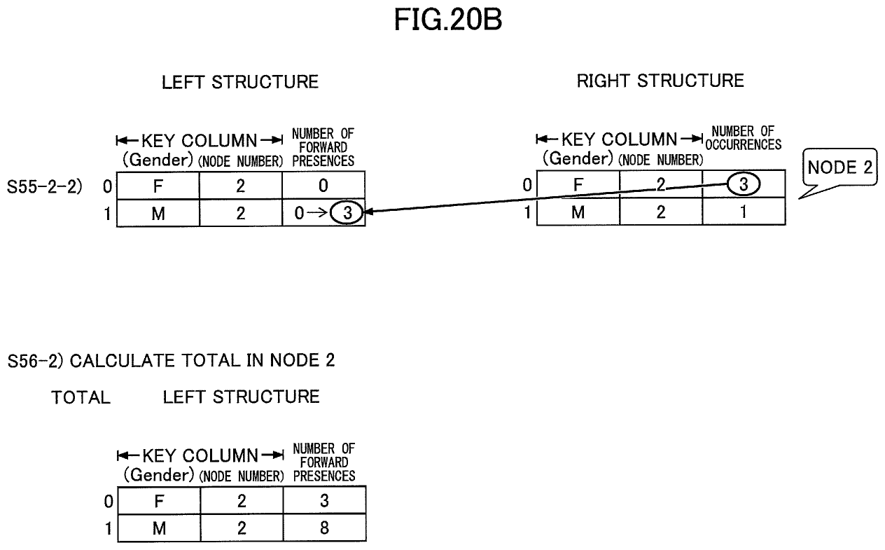

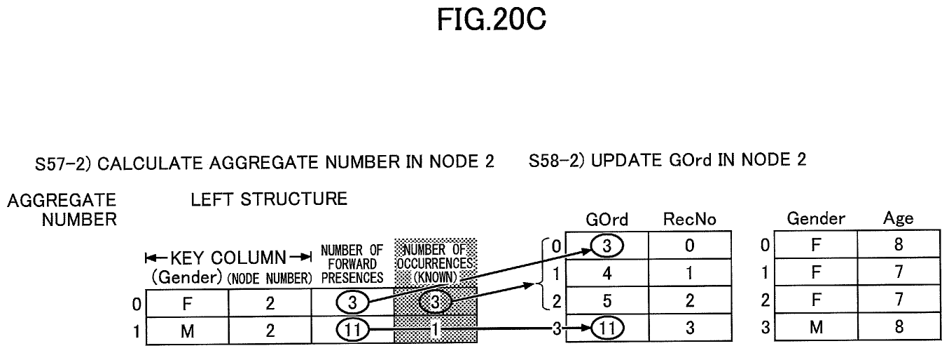

Next, as one example of data processing, a case of sorting by a single item of a gender will be described with reference to FIGS. 17-20. FIGS. 17-20 illustrate an example of single-item sorting. Below, a case of ascending-order sorting by a single item of a gender assuming that a magnitude relationship between genders “F” and “M” is F<M will be described. However, a case of descending-order sorting by a single item of a gender assuming that a magnitude relationship between genders “F” and “M” is F>M may also be assumed.

S51) First, the operation unit 102 of each data processing apparatus 10 sorts by a gender in the own node. That is, the operation unit 102 of each data processing apparatus 10 sorts the record number list stored by the partial table stored by the own storage unit 103 by a gender.

Then, the operation unit 102 of each data processing apparatus 10 generates a record number list storing the sorted record numbers and a GOrd list storing null values.

Thus, in the data processing apparatus 10-0 (the node 0), a record number list where the record numbers have been sorted in the stated order of “0”, “3”, “1”, and “2”; and a GOrd list where null values corresponding to these record numbers are stored are generated. Similarly, in the data processing apparatus 10-1 (the node 1), a record number list where the record numbers have been sorted in the stated order of “2”, “0”, “1”, and “3”; and a GOrd list where null values corresponding to these record numbers are stored are generated. Similarly, in the data processing apparatus 10-2 (the node 2), a record number list where the record numbers have been sorted in the stated order of “0”, “1”, “2”, and “3”; and a GOrd list where null values corresponding to these record numbers are stored are generated.

S52) Next, the operation unit 102 of each data processing apparatus 10 generates a right structure. That is, the operation unit 102 of each data processing apparatus 10 generates a right structure where the gender and the node number of the own node are stored as a “key column” and the number of records having the gender is stored as a “number of occurrences”. Thus, in the data processing apparatus 10-0 (the node 0), a right structure having 2 rows, i.e., a row where the keys “F” and “0” are associated with the number of occurrences “2” and a row where the keys “M” and “0” are associated with the number of occurrences “2” is generated. Similarly, in the data processing apparatus 10-1 (the node 1), a right structure having 2 rows, i.e., a row where the keys “F” and “1” are associated with the number of occurrences “1” and a row where the keys “M” and “1” are associated with the number of occurrences “3” is generated. Similarly, in the data processing apparatus 10-2 (the node 2), a right structure having 2 rows, i.e., a row where the keys “F” and “2” are associated with the number of occurrences “3” and a row where the keys “M” and “2” are associated with the number of occurrences “1” is generated.

Because all of the node numbers included in the single left structure or right structure are the same as each other, it is not necessary to store the node numbers repetitively for the number of records of the left structure and the right structure. In order to reduce the memory amounts and the communication amounts, the node number may be only stored in a single area of the left structure and the right structure.

S53) Next, the operation unit 102 of each data processing apparatus 10 generates a left structure. That is, the operation unit 102 of each data processing apparatus 10 generates a left structure where every number of occurrences of the right structure generated in S52 is changed to 0 and the “numbers of occurrences” are stored as the “numbers of forward presences”.

S54) Next, the communication unit 101 of each data processing apparatus 10 mutually exchanges the right structures generated in S52. That is, the communication unit 101 of each data processing apparatus 10 transmits the right structure of the own node to all the other nodes and receives the right structures transmitted from all the other nodes. Note that S54 may be executed immediately after S52.

The following S55-0 through S57-0 are executed in the node 0, S55-1 through S57-1 are executed in the node 1, and S55-2 through S57-2 are executed in the node 2. In this regard, each node can execute these processes independently. This is because a Global L-operation has the above-mentioned feature 2.

S55-0) The operation unit 102 of the data processing apparatus 10-0 performs an L-operation with a key comparing condition “>”. In detail, the operation unit 102 of the data processing apparatus 10-0 executes the following S55-0-0 through S55-0-2. In this regard, in some cases, for parallel processing of S55-0-0 through S55-0-2 described below, the operation unit 102 of the data processing apparatus 10-0 uses the numbers of⋅forward presences included in the left structures stored in different storage areas, respectively. In other words, in some cases, for parallel processing, the operation unit 102 of the data processing apparatus 10-0 uses the number of forward presences included in the left structure that is for comparison with the right structure of the node 0, the number of forward presences included in the left structure that is for comparison with the right structure of the node 1, and the number of forward presences included in the left structure that is for comparison with the right structure of the node 2. Note that because a Global L-operation has the above-described feature 1, the following S55-0-0 through S55-0-2 may be executed in any order.

S55-0-0) The operation unit 102 of the data processing apparatus 10-0 compares the keys “F” and “0” at the key column of the left structure of the own node with the keys “F” and “0” at the key column of the right structure of the own node (the node 0). In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-0 compares the keys “M” and “0” at the key column of the left structure of the own node with the keys “F” and “0” at the key column of the right structure of the own node (the node 0). In this case, the key comparing condition “>” is satisfied. As a result, the operation unit 102 adds the number of occurrences “2” corresponding to the keys “F” and “0” of the right structure to the number of forward presences corresponding to the keys “M” and “0” of the left structure. Then, the operation unit 102 lowers the reference position in the right structure by one. Thus, the number of forward presences at the operating position “1” of the left structure is updated from “0” to “2” and the reference position in the right structure is updated from “0” to “1”.

Next, the operation unit 102 of the data processing apparatus 10-0 compares the keys “M” and “0” at the key column of the left structure of the own node with the keys “M” and “0” at the key column of the right structure of the own node (the node 0). In this case, the key comparing condition “>” is not satisfied. As a result, the operation unit 102 would lower the operating position in the left structure by one. However, it is not possible to further lower the operating position. Therefore, the operation unit 102 ends the L-operation.

S55-0-1) The operation unit 102 of the data processing apparatus 10-0 compares the keys “F” and “0” at the key column of the left structure of the own node with the keys “F” and “0” at the key column of the right structure of the node 1. In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-0 compares the keys “M” and “0” at the key column of the left structure of the own node with the keys “F” and “1” at the key column of the right structure of the node 1. In this case, the key comparing condition “>” is satisfied. As a result, the operation unit 102 adds the number of occurrences “1” corresponding to the keys “F” and “1” of the right structure to the number of forward presences corresponding to the keys “M” and “0” of the left structure. Then, the operation unit 102 lowers the reference position in the right structure by one. Thus, the number of forward presences at the operating position “1” of the left structure is updated from “0” to “1” and the reference position in the right structure is updated from “0” to “1”.

Next, the operation unit 102 of the data processing apparatus 10-0 compares the keys “M” and “0” at the key column of the left structure of the own node with the keys “M” and “1” at the key column of the right structure of the node 1. In this case, the key comparing condition “>” is not satisfied. As a result, the operation unit 102 would lower the operating position in the left structure by one. However, it is not possible to further lower the operating position. Therefore, the operation unit 102 ends the L-operation.

S55-0-2) The operation unit 102 of the data processing apparatus 10-0 compares the keys “F” and “0” at the key column of the left structure of the own node with the keys “F” and “2” at the key column of the right structure of the node 2. In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-0 compares the keys “M” and “0” at the key column of the left structure of the own node with the keys “F” and “2” at the key column of the right structure of the node 2. In this case, the key comparing condition “>” is satisfied. As a result, the operation unit 102 adds the number of occurrences “3” corresponding to the keys “F” and “2” of the right structure to the number of forward presences corresponding to the keys “M” and “0” of the left structure. Then, the operation unit 102 lowers the reference position in the right structure by one. Thus, the number of forward presences at the operating position “1” of the left structure is updated from “0” to “3” and the reference position in the right structure is updated from “0” to “1”.

Next, the operation unit 102 of the data processing apparatus 10-0 compares the keys “M” and “0” at the key column of the left structure of the own node with the keys “M” and “2” at the key column of the right structure of the node 2. In this case, the key comparing condition “>” is not satisfied. As a result, the operation unit 102 would lower the operating position in the left structure by one. However, it is not possible to further lower the operating position. Therefore, the operation unit 102 ends the L-operation.

S56-0) Next, the operation unit 102 of the data processing apparatus 10-0 calculates a total of the numbers of forward presences of the left structures. That is, the operation unit 102 of the data processing apparatus 10-0 calculates a total of the respective numbers of forward presences of the left structure that is for comparison with the right structure of the node 0, of the left structure that is for comparison with the right structure of the node 1, and of the left structure that is for comparison with the right structure of the node 2. Thus, the (total) number of forward presences corresponding to the gender “F” is “0”; the (total) number of forward presences corresponding to the gender “M” is “6”.

S57-0) Next, the operation unit 102 of the data processing apparatus 10-0 aggregates the (total) numbers of forward presences calculated in S56-0. That is, the operation unit 102 of the data processing apparatus 10-0 leaves the number of forward presences corresponding to the gender “F” as it is while changing the number of forward presences corresponding to the gender “M” to be the number of forward presences corresponding to the gender “F”+the number of forward presences corresponding to the gender “M”.

Thus, the number of forward presences corresponding to the gender “F” is “0”; the number of forward presences corresponding to the gender “M” is “6”. These numbers of forward presences will be used as start numbers of GOrd values on a per-gender basis in the node 0. In this case, the start number of a GOrd value for the gender “F” in the node 0 is “0”; the start number of a GOrd value for the gender “M” in the node 0 is “6”.

S58-0) Next, the operation unit 102 of the data processing apparatus 10-0 uses the aggregate numbers of forward presences calculated in S57-0 and the numbers of occurrences obtained in S52 and updates the GOrd list of the own node generated in S51. That is, the operation unit 102 of the data processing apparatus 10-0 stores, in the GOrd list, on a per-gender basis, values that start from the aggregate numbers of forward presences and that are incremented from the top places, one by one, the numbers of times corresponding to the numbers of occurrences. Thus, in the GOrd list of the node 0, a GOrd value “0” is stored at the storing position “0”, a GOrd value “1” is stored at the storing position “1”, a GOrd value “6” is stored at the storing position “2”, and a GOrd value “7” is stored at the storing position “3”.

S55-1) The operation unit 102 of the data processing apparatus 10-1 performs an L-operation with a key comparing condition “>”. In detail, the operation unit 102 of the data processing apparatus 10-0 executes the following S55-1-0 through S55-1-2. In this regard, in some cases, for parallel processing of S55-1-0 through S55-1-2 described below, the operation unit 102 of the data processing apparatus 10-1 uses the numbers of forward presences included in the left structures stored in different storage areas, respectively. In other words, in some cases, for parallel processing, the operation unit 102 of the data processing apparatus 10-1 uses the number of forward presences included in the left structure that is for comparison with the right structure of the node 0, the number of forward presences included in the left structure that is for comparison with the right structure of the node 1, and the number of forward presences included in the left structure that is for comparison with the right structure of the node 2. Note that because a Global L-operation has the above-described feature 1, the following S55-1-0 through S55-1-2 may be executed in any order.

S55-1-0) The operation unit 102 of the data processing apparatus 10-1 compares the keys “F” and “1” at the key column of the left structure of the own node with the keys “F” and “0” at the key column of the right structure of the node 0. In this case, the key comparing condition “>” is satisfied. As a result, the operation unit 102 adds the number of occurrences “2” corresponding to the keys “F” and “0” of the right structure to the number of forward presences corresponding to the keys “F” and “1” of the left structure. Then, the operation unit 102 lowers the reference position in the right structure by one. Thus, the number of forward presences at the operating position “0” of the left structure is updated from “0” to “2” and the reference position in the right structure is updated from “0” to “1”.

Next, the operation unit 102 of the data processing apparatus 10-1 compares the keys “F” and “1” at the key column of the left structure of the own node with the keys “M” and “0” at the key column of the right structure of the node 0. In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-1 compares the keys “M” and “1” at the key column of the left structure of the own node with the keys “M” and “0” at the key column of the right structure of the own node 0. In this case, the key comparing condition “>” is satisfied. As a result, the operation unit 102 adds the number of occurrences “2” corresponding to the keys “M” and “0” of the right structure to the number of forward presences corresponding to the keys “M” and “1” of the left structure. Then, the operation unit 102 would lower the reference position in the right structure by one. However, it is not possible to further lower the operating position. Therefore, the operation unit 102 ends the L-operation. Thus, the number of forward presences at the operating position “1” of the left structure is updated from “0” to “2”.

S55-1-1) The operation unit 102 of the data processing apparatus 10-1 compares the keys “F” and “1” at the key column of the left structure of the own node with the keys “F” and “1” at the key column of the right structure of the own node (the node 1). In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-1 compares the keys “M” and “1” at the key column of the left structure of the own node with the keys “F” and “1” at the key column of the right structure of the own node (the node 1). In this case, the key comparing condition “>” is satisfied. As a result, the operation unit 102 adds the number of occurrences “1” corresponding to the keys “F” and “1” of the right structure to the number of forward presences corresponding to the keys “M” and “1” of the left structure. Then, the operation unit 102 lowers the reference position in the right structure by one. Thus, the number of forward presences at the operating position “1” of the left structure is updated from “0” to “1” and the reference position in the right structure is updated from “0” to “1”.

Next, the operation unit 102 of the data processing apparatus 10-1 compares the keys “M” and “1” at the key column of the left structure of the own node with the keys “M” and “1” at the key column of the right structure of the own node (the node 1). In this case, the key comparing condition “>” is not satisfied. As a result, the operation unit 102 would lower the operating position in the left structure by one. However, it is not possible to further lower the operating position. Therefore, the operation unit 102 ends the L-operation.

S55-1-2) The operation unit 102 of the data processing apparatus 10-1 compares the keys “F” and “1” at the key column of the left structure of the own node with the keys “F” and “2” at the key column of the right structure of the node 2. In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-1 compares the keys “M” and “1” at the key column of the left structure of the own node with the keys “F” and “2” at the key column of the right structure of the node 2. In this case, the key comparing condition “>” is satisfied. As a result, the operation unit 102 adds the number of occurrences “3” corresponding to the keys “F” and “2” of the right structure to the number of forward presences corresponding to the keys “M” and “1” of the left structure. Then, the operation unit 102 lowers the reference position in the right structure by one. Thus, the number of forward presences at the operating position “1” of the left structure is updated from “0” to “3” and the reference position in the right structure is updated from “0” to “1”.

Next, the operation unit 102 of the data processing apparatus 10-1 compares the keys “M” and “1” at the key column of the left structure of the own node with the keys “M” and “2” at the key column of the right structure of the node 2. In this case, the key comparing condition “>” is not satisfied. As a result, the operation unit 102 would lower the operating position in the left structure by one. However, it is not possible to further lower the operating position. Therefore, the operation unit 102 ends the L-operation.

S56-1) Next, the operation unit 102 of the data processing apparatus 10-1 calculates a total of the numbers of forward presences of the left structures. That is, the operation unit 102 of the data processing apparatus 10-1 calculates a total of the respective numbers of forward presences of the left structure that is for comparison with the right structure of the node 0, of the left structure that is for comparison with the right structure of the node 1, and of the left structure that is for comparison with the right structure of the node 2. Thus, the (total) number of forward presences corresponding to the gender “F” is “2”; the (total) number of forward presences corresponding to the gender “M” is “6”.

S57-1) Next, the operation unit 102 of the data processing apparatus 10-1 aggregates the (total) numbers of forward presences calculated in S56-1. That is, the operation unit 102 of the data processing apparatus 10-1 leaves the number of forward presences corresponding to the gender “F” as it is while changing the number of forward presences corresponding to the gender “M” to be the number of forward presences corresponding to the gender “F”+the number of forward presences corresponding to the gender “M”.

Thus, the number of forward presences corresponding to the gender “F” is “2”; the number of forward presences corresponding to the gender “M” becomes “8”. These numbers of forward presences will be used as start numbers of GOrd values on a per-gender basis in the node 1. In this case, the start number of a GOrd value for the gender “F” in the node 0 is “2”; the start number of a GOrd value for the gender “M” in the node 0 is “8”.

S58-1) Next, the operation unit 102 of the data processing apparatus 10-1 uses the aggregate numbers of forward presences calculated in S57-1 and the numbers of occurrences obtained in S52 and updates the GOrd list of the own node generated in S51. That is, the operation unit 102 of the data processing apparatus 10-1 stores, in the GOrd list, on a per-gender basis, values that start from the aggregate numbers of forward presences and that are incremented from the top places, one by one, the numbers of times corresponding to the numbers of occurrences. Thus, in the GOrd list of the node 1, a GOrd value “2” is stored at the storing position “0”, a GOrd value“8” is stored at the storing position “1”, a GOrd value “9” is stored at the storing position “2”, and a GOrd value “10” is stored at the storing position “3”.

S55-2) The operation unit 102 of the data processing apparatus 10-2 performs an L-operation with a key comparing condition “>”. In detail, the operation unit 102 of the data processing apparatus 10-0 executes the following S55-2-0 through S55-2-2. In this regard, in some cases, for parallel processing of S55-2-0 through S55-2-2 described below, the operation unit 102 of the data processing apparatus 10-2 uses the numbers of forward presences included in the left structures stored in different storage areas, respectively. In other words, in some cases, for parallel processing, the operation unit 102 of the data processing apparatus 10-2 uses the number of forward presences included in the left structure that is for comparison with the right structure of the node 0, the number of forward presences included in the left structure that is for comparison with the right structure of the node 1, and the number of forward presences included in the left structure that is for comparison with the right structure of the node 2. Note that because a Global L-operation has the above-described feature 1, the following S55-2-0 through S55-2-2 may be executed in any order.

S55-2-0) The operation unit 102 of the data processing apparatus 10-2 compares the keys “F” and “2” at the key column of the left structure of the own node with the keys “F” and “0” at the key column of the right structure of the node 0. In this case, the key comparing condition “>” is satisfied. As a result, the operation unit 102 adds the number of occurrences “2” corresponding to the keys “F” and “0” of the right structure to the number of forward presences corresponding to the keys “F” and “2” of the left structure. Then, the operation unit 102 lowers the reference position in the right structure by one. Thus, the number of forward presences at the operating position “0” of the left structure is updated from “0” to “2” and the reference position in the right structure is updated from “0” to “1”.

Next, the operation unit 102 of the data processing apparatus 10-2 compares the keys “F” and “2” at the key column of the left structure of the own node with the keys “M” and “0” at the key column of the right structure of the node 0. In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-2 compares the keys “M” and “2” at the key column of the left structure of the own node with the keys “M” and “0” at the key column of the right structure of the node 0. In this case, the key comparing condition “>” is satisfied. As a result, the operation unit 102 adds the number of occurrences “2” corresponding to the keys “M” and “2” of the right structure to the number of forward presences corresponding to the keys “M” and “2” of the left structure. Then, the operation unit 102 would lower the reference position in the right structure by one. However, it is not possible to further lower the operating position. Therefore, the operation unit 102 ends the L-operation. Thus, the number of forward presences at the operating position “1” of the left structure is updated from “0” to “2”.

S55-2-1) The operation unit 102 of the data processing apparatus 10-2 compares the keys “F” and “2” at the key column of the left structure of the own node with the keys “F” and “1” at the key column of the right structure of the node 1. In this case, the key comparing condition “>” is satisfied. As a result, the operation unit 102 adds the number of occurrences “1” corresponding to the keys “F” and “1” of the right structure to the number of forward presences corresponding to the keys “F” and “2” of the left structure. Then, the operation unit 102 lowers the reference position in the right structure by one. Thus, the number of forward presences at the operating position “0” of the left structure is updated from “0” to “1” and the reference position in the right structure is updated from “0” to “1”.

Next, the operation unit 102 of the data processing apparatus 10-2 compares the keys “F” and “2” at the key column of the left structure of the own node with the keys “M” and “1” at the key column of the right structure of the node 1. In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-2 compares the keys “M” and “2” at the key column of the left structure of the own node with the keys “M” and “1” at the key column of the right structure of the own node 1. In this case, the key comparing condition “>” is satisfied.

As a result, the operation unit 102 adds the number of occurrences “3” corresponding to the keys “M” and “1” of the right structure to the number of forward presences corresponding to the keys “M” and “2” of the left structure. Then, the operation unit 102 would lower the reference position in the right structure by one. However, it is not possible to further lower the reference position. Therefore, the operation unit 102 ends the L-operation. Thus, the number of forward presences at the operating position “1” of the left structure is updated from “0” to “3”.

S55-2-2) The operation unit 102 of the data processing apparatus 10-2 compares the keys “F” and “2” at the key column of the left structure of the own node with the keys “F” and “2” at the key column of the right structure of the own node (the node 2). In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-2 compares the keys “M” and “2” at the key column of the left structure of the own node with the keys “F” and “2” at the key column of the right structure of the own node (the node 2). In this case, the key comparing condition “>” is satisfied. As a result, the operation unit 102 adds the number of occurrences “3” corresponding to the keys “F” and “2” of the right structure to the number of forward presences corresponding to the keys “M” and “2” of the left structure. Then, the operation unit 102 lowers the reference position in the right structure by one. Thus, the number of forward presences at the operating position “1” of the left structure is updated from “0” to “3” and the reference position in the right structure is updated from “0” to “1”.

Next, the operation unit 102 of the data processing apparatus 10-2 compares the keys “M” and “2” at the key column of the left structure of the own node with the keys “M” and “2” at the key column of the right structure of the own node (the node 2). In this case, the key comparing condition “>” is not satisfied. As a result, the operation unit 102 would lower the operating position in the left structure by one. However, it is not possible to further lower the operating position. Therefore, the operation unit 102 ends the L-operation.

S56-2) Next, the operation unit 102 of the data processing apparatus 10-2 calculates a total of the numbers of forward presences of the left structures. That is, the operation unit 102 of the data processing apparatus 10-2 calculates a total of the respective numbers of forward presences of the left structure that is for comparison with the right structure of the node 0, of the left structure that is for comparison with the right structure of the node 1, and of the left structure that is for comparison with the right structure of the node 2. Thus, the (total) number of forward presences corresponding to the gender “F” is “3”; the (total) number of forward presences corresponding to the gender “M” is “8”.

S57-2) Next, the operation unit 102 of the data processing apparatus 10-2 aggregates the (total) numbers of forward presences calculated in S56-2. That is, the operation unit 102 of the data processing apparatus 10-1 leaves the number of forward presences corresponding to the gender “F” as it is while changing the number of forward presences corresponding to the gender “M” to be the number of forward presences corresponding to the gender “F”+the number of forward presences corresponding to the gender “M”.

Thus, the number of forward presences corresponding to the gender “F” is “3”; the number of forward presences corresponding to the gender “M” becomes “11”. These numbers of forward presences will be used as start numbers of GOrd values on a per-gender basis in the node 2. In this case, the start number of a GOrd value for the gender “F” in the node 2 is “3”; the start number of a GOrd value for the gender “M” in the node 2 is “11”.

S58-2) Next, the operation unit 102 of the data processing apparatus 10-2 uses the aggregate number of forward presences calculated in S57-2 and the number of occurrences obtained in S52 and updates the GOrd list of the own node generated in S51. That is, the operation unit 102 of the data processing apparatus 10-2 stores, in the GOrd list, on a per-gender basis, values that start from the aggregate numbers of forward presences and that are incremented from the top places, one by one, the numbers of times corresponding to the numbers of occurrences. Thus, in the GOrd list of the node 2, a GOrd value “3” is stored at the storing position “0”, a GOrd value “4” is stored at the storing position “1”, a GOrd value “5” is stored at the storing position “2”, and a GOrd value“11” is stored at the storing position “3”.

Thus, the GOrd values are stored in each GOrd list generated in S51. Thus, in each data processing apparatus 10, the partial table where the GOrd values (and the record numbers) are provided is obtained; through the GOrd values, a sorting result (a single-item sorting result) with respect to all of the data processing apparatuses 10 is obtained.

<Multi-Item Sorting>

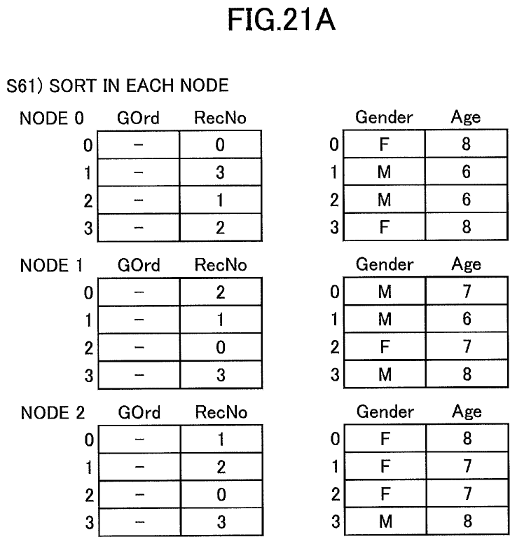

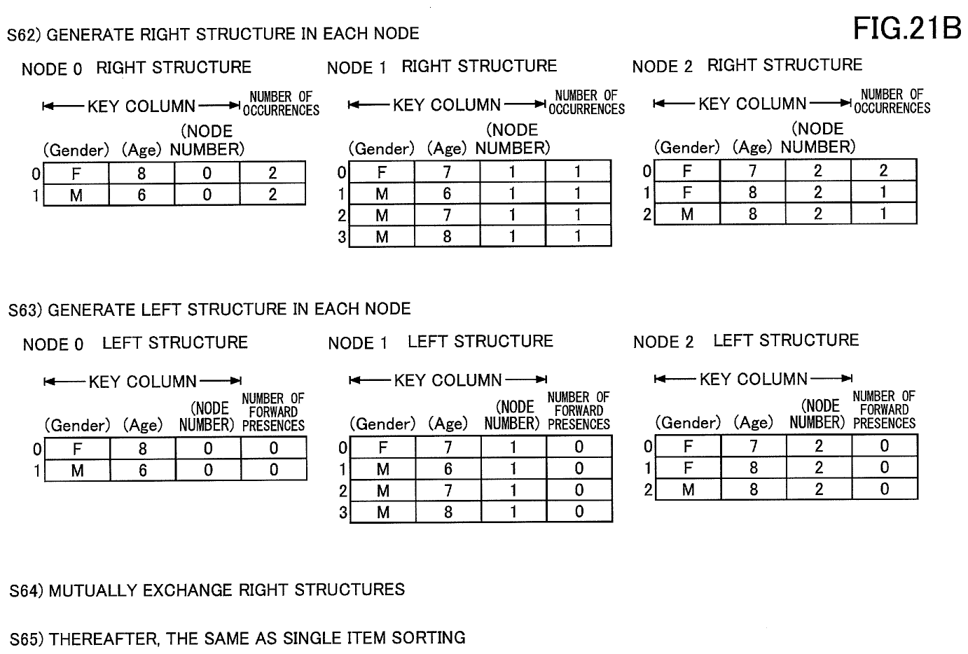

Next, as one example of data processing, sorting with a plurality of items of a gender and an age will be described with reference to FIG. 21. FIG. 21 illustrates one example of multi-item sorting.

S61) First, the operation unit 102 of each data processing apparatus 10 sorts by a gender and an age in the own node. That is, the operation unit 102 of each data processing apparatus 10 sorts the record number list stored by the partial table stored by the own storage unit 103 by a gender and an age.

Then, the operation unit 102 of each data processing apparatus 10 generates a record number list storing the record numbers of the records obtained from the sorting, and a GOrd list storing null values.

Thus, in the data processing apparatus 10-0 (the node 0), a record number list where the record numbers have been sorted in the stated order of “0”, “3”, “1”, and “2”; and a GOrd list where null values corresponding to these record numbers are stored are generated. Similarly, in the data processing apparatus 10-1 (the node 1), a record number list where the record numbers have been sorted in the stated order of “2”, “1”, “0”, and “3”; and a GOrd list where null values corresponding to these record numbers are stored are generated. Similarly, in the data processing apparatus 10-2 (the node 2), a record number list where the record numbers have been sorted in the stated order of “1”, “2”, “0”, and “3”; and a GOrd list where null values corresponding to these record numbers are stored are generated.

S62) Next, the operation unit 102 of each data processing apparatus 10 generates a right structure. That is, the operation unit 102 of each data processing apparatus 10 generates a right structure where the gender, the age, and the node number of the own node are stored as a “key column” and the number of records having the gender and the age is stored as a “number of occurrences”. Thus, in the data processing apparatus 10-0 (the node 0), a right structure having 2 rows, i.e., a row where the keys “F”, “8”, and “0” are associated with the number of occurrences “2” and a row where the keys “M”, “6”, and “0” are associated with the number of occurrences “2” is generated. Similarly, in the data processing apparatus 10-1 (the node 1), a right structure having 4 rows, i.e., a row where the keys “F”, “7”, and “1” are associated with the number of occurrences “1”, a row where the keys “M”, “6”, and “1” are associated with the number of occurrences “1”, a row where the keys “M”, “7”, and “1” are associated with the number of occurrences “1”, and a row where the keys “M”, “8”, and “1” are associated with the number of occurrences “1” is generated. Similarly, in the data processing apparatus 10-2 (the node 2), a right structure having 3 rows, i.e., a row where the keys “F”, “7”, and “2” are associated with the number of occurrences “2”, a row where the keys “F”, “8”, and “2” are associated with the number of occurrences “1”, and a row where the keys “M”, “8”, and “2” are associated with the number of occurrences “1” is generated.

S63) Next, the operation unit 102 of each data processing apparatus 10 generates a left structure. That is, the operation unit 102 of each data processing apparatus 10 generates a left structure where every number of occurrences in the right structure generated in S62 is changed to 0 and the “numbers of occurrences” are stored as the “number of forward presences”.

S64) Next, the communication unit 101 of each data processing apparatus 10 mutually exchanges the right structures generated in S62. That is, the communication unit 101 of each data processing apparatus 10 transmits the right structure of the own node to all the others node and receives the right structures transmitted from all of the other nodes. Note that S64 may be executed immediately after S62.

S65) Thereafter, in the same manner as the manner of single-item sorting, S55-k through S58-k are executed for k=0, 1, 2.

Thus, the GOrd values are stored in each GOrd list generated in S61. Thus, in each data processing apparatus 10, the partial table where the GOrd values (and the record numbers) are provided is obtained; through the GOrd values, a sorting result (a multi-item sorting result) with respect to all of the data processing apparatuses 10 is obtained.

<Sorting of Subset>

Next, sorting of a subset will be described. A subset is a set or the like obtained as a result of certain data processing being performed on each partial table; and may be a proper subset of a set (a universal set) expressed by the whole partial table, and may be a set where the order of elements of the universal set is updated. That is, a subset according to an embodiment of the present invention may be not only a set (a proper subset) that is a part of a universal set but also a set having the same number of elements as the elements of a universal set and having the order of the elements changed.

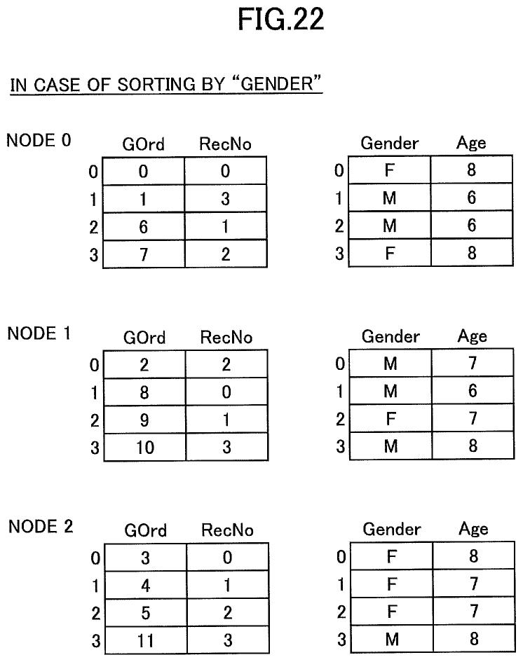

In this regard, a case where a set has the same number of elements as the elements of a universal set and has the order of the elements changed is a case where sorting or the like has been performed on the universal set. FIG. 22 illustrates a subset where sorting by a gender has been performed. As illustrated in FIG. 22, according to an embodiment of the present invention, also for a case where a set has the same number of elements as the elements of a universal set and has the order of the elements changed as a result of sorting by a gender, the set is regarded as a subset.

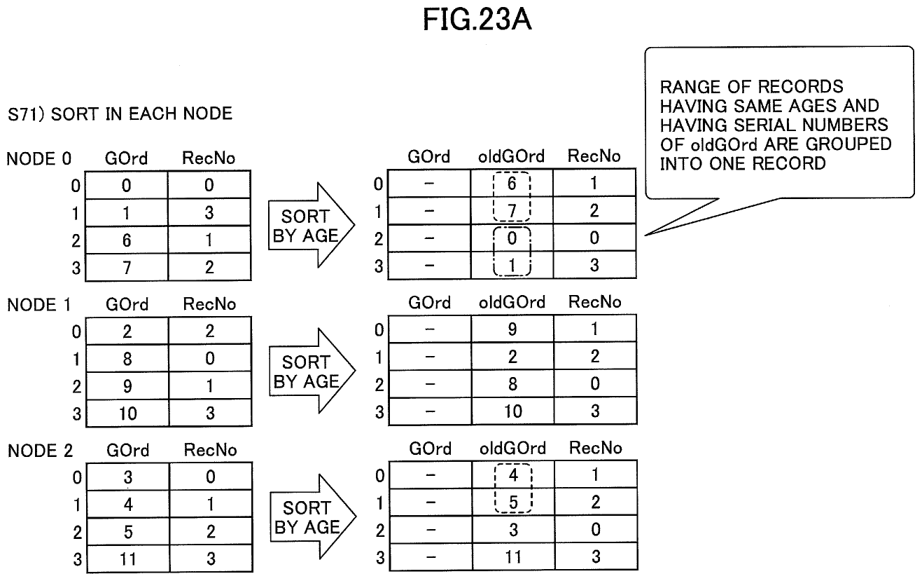

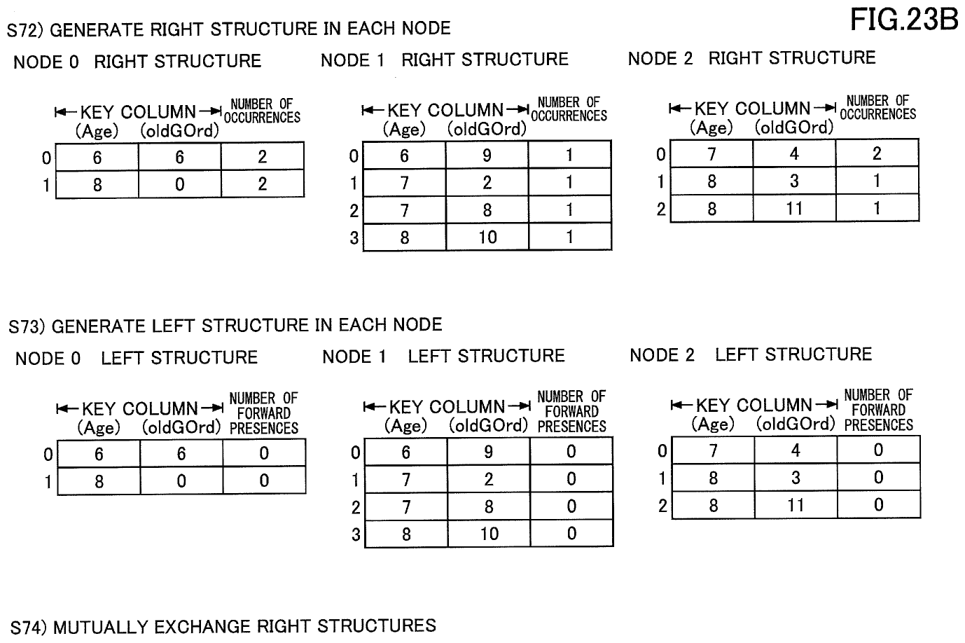

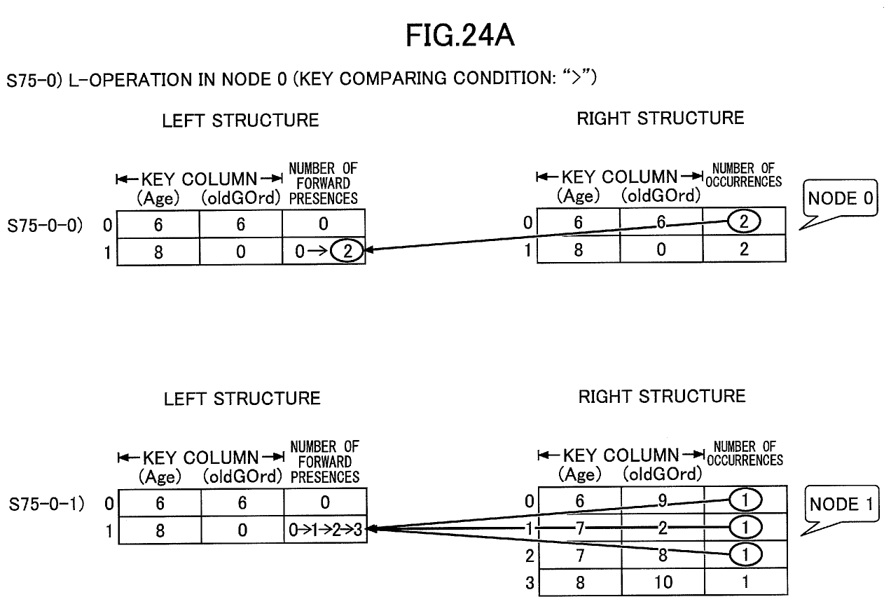

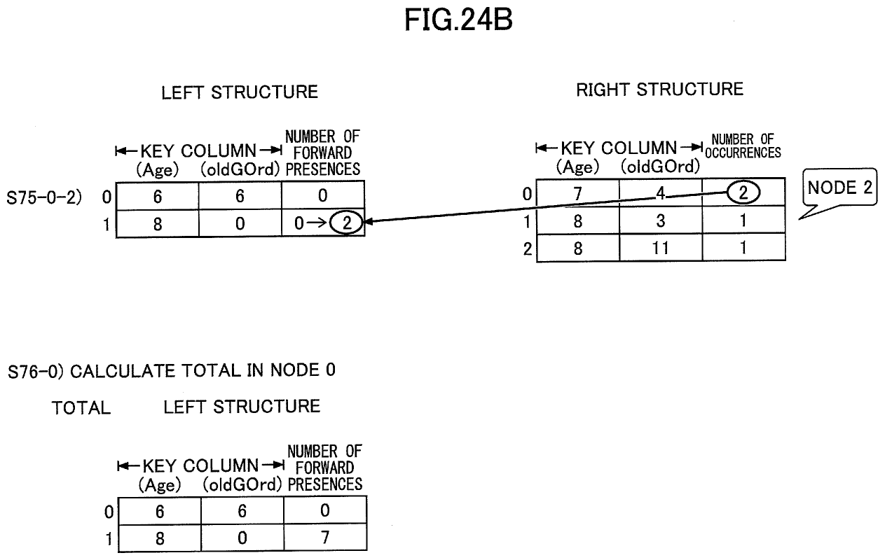

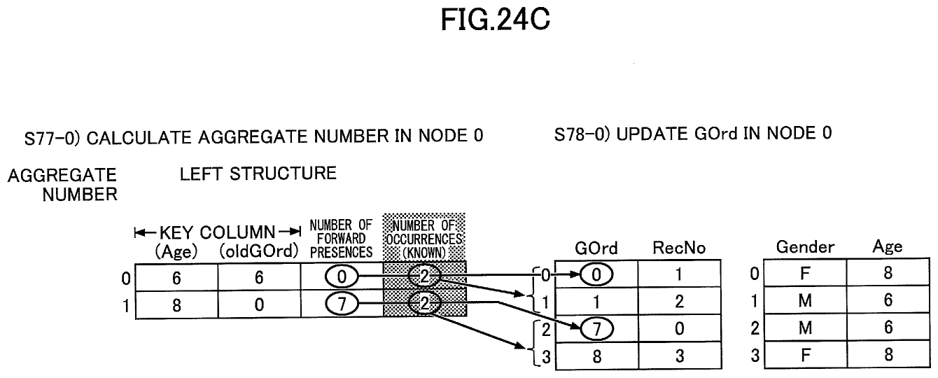

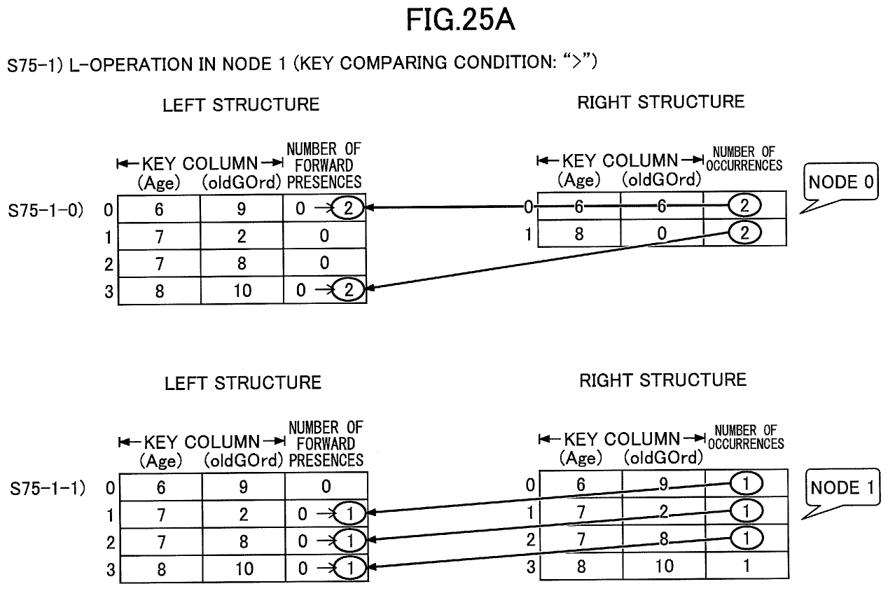

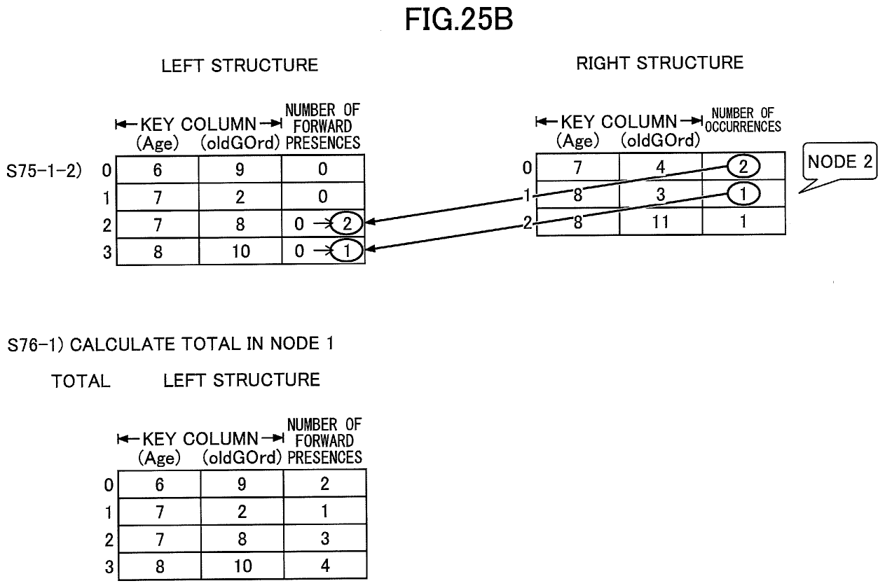

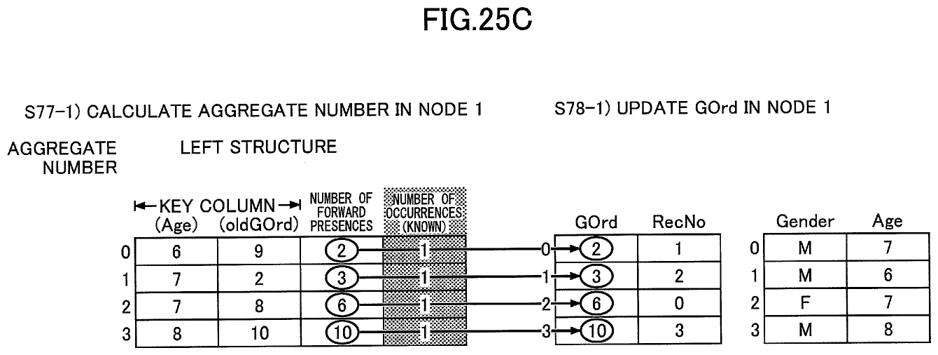

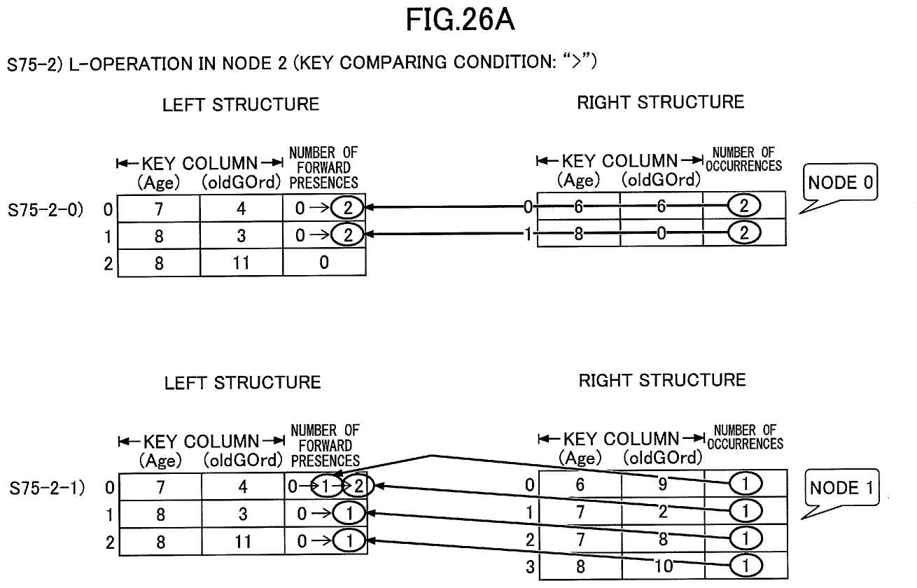

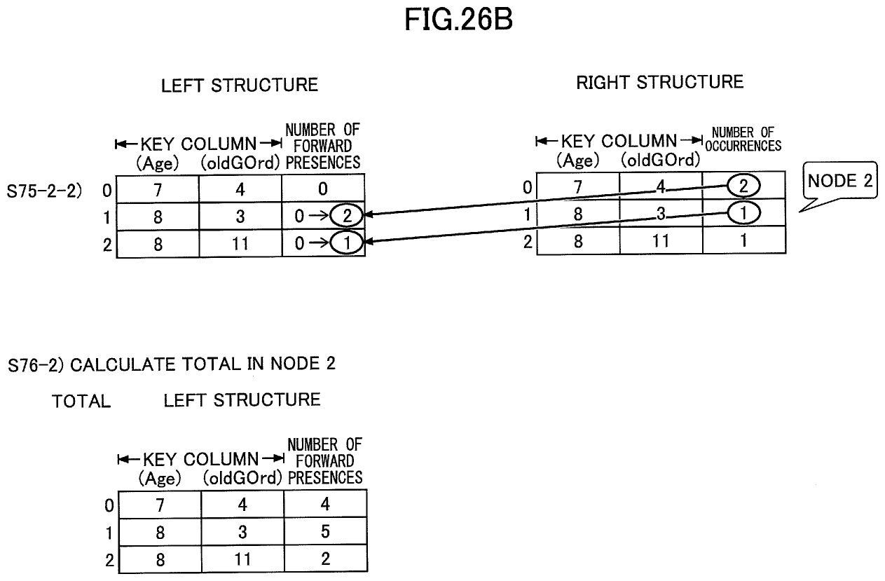

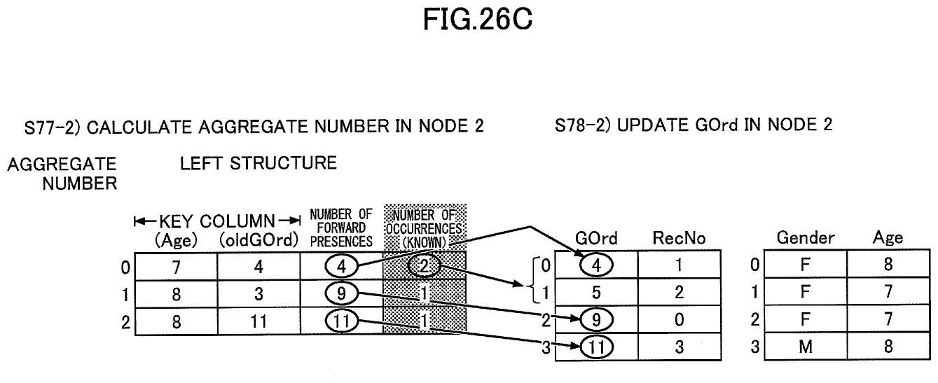

A partial table expressing such a subset is not necessarily a subset for which a stability condition is satisfied. Therefore, below, sorting for a case where each node stores a partial table for which a stability condition is not necessarily satisfied will be described. As one example, a case of sorting by an age assuming that respective nodes store partial tables illustrated in FIG. 22 will be described with reference to FIGS. 23-26. FIGS. 23-26 illustrate one example of sorting of a subset.

S71) First, the operation unit 102 of each data processing apparatus 10 performs sorting by an age in the own node. That is, the operation unit 102 of each data processing apparatus 10 sorts the record number list stored by the partial table stored by the own storage unit 103 by an age.

Then, the operation unit 102 of each data processing apparatus 10 generates a record number list storing the record numbers of the records obtained from the sorting, an oldGOrd list storing the current GOrd values (before the sorting) (hereinafter, also referred to as “oldGOrd” values) for the record numbers, and a GOrd list storing null values.

Thus, in the data processing apparatus 10-0 (the node 0), a record number list where the record numbers have been sorted in the stated order of “1”, “2”, “0”, and “3”; an oldGOrd list where the oldGOrd values corresponding to these record numbers are stored in the stated order of “6”, “7”, “0”, and “1”; and a GOrd list where null values corresponding to these record numbers are stored are generated. Similarly, in the data processing apparatus 10-1 (the node 1), a record number list where the record numbers have been sorted in the stated order of “1”, “2”, “0”, and “3”; an oldGOrd list where the oldGOrd values corresponding to these record numbers are stored in the stated order of “9”, “2”, “8”, and “10”; and a GOrd list where null values corresponding to these record numbers are stored are generated. Similarly, in the data processing apparatus 10-2 (the node 2), a record number list where the record numbers have been sorted in the stated order of “1”, “2”, “0”, and “3”; an oldGOrd list where the oldGOrd values corresponding to these record numbers are stored in the stated order of “4”, “5”, “3”, and “11”; and a GOrd list where null values corresponding to these record numbers are stored are generated.

S72) Next, the operation unit 102 of each data processing apparatus 10 generates a right structure. That is, the operation unit 102 of each data processing apparatus 10 first groups, in the oldGOrd list generated in S72, records in a range where the same age is associated with the records and the oldGOrd values are serial numbers (the range is also referred to as a “serial number range”) into one record and then the serial number range is represented by the top oldGOrd value of the serial number range. Then, the operation unit 102 of each data processing apparatus 10 generates a right structure where the age and the oldGOrd value or the oldGOrd value representing a serial number range are stored as a “key column” and 1 or the number of oldGOrd values included in the serial number range is stored as a “number of occurrences”. In this regard, the number of occurrences “1” is associated with an oldGOrd value not representing a serial number range. That is, the number of oldGOrd values included in a serial number range is stored as the number of occurrences for a case where the corresponding oldGOrd value represents the serial number range whereas 1 (i.e., the corresponding number of oldGOrd values) is stored as the number of occurrences for a case where the corresponding oldGOrd value does not represent a serial number range.

Thus, in the data processing apparatus 10-0 (the node 0), a right structure having 2 rows, i.e., a row where the keys “6” and “6” are associated with the number of occurrences “2” and a row where the keys “8” and “0” are associated with the number of occurrences “2” is generated. Similarly, in the data processing apparatus 10-1 (the node 1), a right structure having 4 rows, i.e., a row where the keys “6” and “9” are associated with the number of occurrences “1”, a row where the keys “7” and “2” are associated with the number of occurrences “1”, a row where the keys “7” and “8” are associated with the number of occurrences “1”, and a row where the keys “8” and “10” are associated with the number of occurrences “1” is generated. Similarly, in the data processing apparatus 10-2 (the node 2), a right structure having 3 rows, i.e., a row where the keys “7” and “4” are associated with the number of occurrences “2”, a row where the keys “8” and “3” are associated with the number of occurrences “1”, and a row where the keys “8” and “11” are associated with the number of occurrences “1” is generated.

S73) Next, the operation unit 102 of each data processing apparatus 10 generates a left structure. That is, the operation unit 102 of each data processing apparatus 10 generates a left structure where every number of occurrences is changed to “0” in the right structure generated in S72 and the “numbers of occurrences” are stored as the “numbers of forward presences”.

S74) Next, the communication unit 101 of each data processing apparatus 10 mutually exchanges the right structures generated in S72. That is, the communication unit 101 of each data processing apparatus 10 transmits the right structure of the own node to all the other nodes and receives the right structures transmitted from all of the other nodes. Note that S74 may be executed immediately after S72.

The following S75-0 through S78-0 are executed in the node 0, S75-1 through S78-1 are executed in the node 1, and S75-2 through S78-2 are executed in the node 2. In this regard, each node may execute these processes independently. This is because a Global L-operation has the above-mentioned feature 2.

S75-0) The operation unit 102 of the data processing apparatus 10-0 performs an L-operation with a key comparing condition “>”. In detail, the operation unit 102 of the data processing apparatus 10-0 executes the following S75-0-0 through S75-0-2. In this regard, in some cases, for parallel processing of S75-0-0 through S75-0-2 described below, the operation unit 102 of the data processing apparatus 10-0 uses the numbers of forward presences included in the left structures stored in different storage areas, respectively. In other words, in some cases, for parallel processing, the operation unit 102 of the data processing apparatus 10-0 uses the number of forward presences included in the left structure that is for comparison with the right structure of the node 0, the number of forward presences included in the left structure that is for comparison with the right structure of the node 1, and the number of forward presences included in the left structure that is for comparison with the right structure of the node 2. Note that because a Global L-operation has the above-described feature 1, the following S75-0-0 through S75-0-2 may be executed in any order.

S75-0-0) The operation unit 102 of the data processing apparatus 10-0 compares the keys “6” and “6” at the key column of the left structure of the own node with the keys “6” and “6” at the key column of the right structure of the own node (the node 0). In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-0 compares the keys “8” and “0” at the key column of the left structure of the own node with the keys “6” and “6” at the key column of the right structure of the own node (the node 0). In this case, the key comparing condition “>” is satisfied. As a result, the operation unit 102 adds the number of occurrences “2” corresponding to the keys “6” and “6” of the right structure to the number of forward presences corresponding to the keys “8” and “0” of the left structure. Then, the operation unit 102 lowers the reference position in the right structure by one. Thus, the number of forward presences at the operating position “1” of the left structure is updated from “0” to “2” and the reference position in the right structure is updated from “0” to “1”.

Next, the operation unit 102 of the data processing apparatus 10-0 compares the keys “8” and “0” at the key column of the left structure of the own node with the keys “8” and “0” at the key column of the right structure of the own node (the node 0). In this case, the key comparing condition “>” is not satisfied. As a result, the operation unit 102 would lower the operating position in the left structure by one. However, it is not possible to further lower the operating position. Therefore, the operation unit 102 ends the L-operation.

S75-0-1) The operation unit 102 of the data processing apparatus 10-0 compares the keys “6” and “6” at the key column of the left structure of the own node with the keys “6” and “9” at the key column of the right structure of the node 1. In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-0 compares the keys “8” and “0” at the key column of the left structure of the own node with the keys “6” and “9” at the key column of the right structure of the own node 1. In this case, the key comparing condition “>” is satisfied. As a result, the operation unit 102 adds the number of occurrences “1” corresponding to the keys “6” and “9” of the right structure to the number of forward presences corresponding to the keys “8” and “0” of the left structure. Then, the operation unit 102 lowers the reference position in the right structure by one. Thus, the number of forward presences at the operating position “1” of the left structure is updated from “0” to “1” and the reference position in the right structure is updated from “0” to “1”.

Next, the operation unit 102 of the data processing apparatus 10-0 compares the keys “8” and “0” at the key column of the left structure of the own node with the keys “7” and “2” at the key column of the right structure of the node 1. In this case, the key comparing condition “>” is satisfied. As a result, the operation unit 102 adds the number of occurrences “1” corresponding to the keys “7” and “2” of the right structure to the number of forward presences corresponding to the keys “8” and “0” of the left structure. Then, the operation unit 102 lowers the reference position in the right structure by one. Thus, the number of forward presences at the operating position “1” of the left structure is updated from “1” to “2” and the reference position in the right structure is updated from “1” to “2”.

Next, the operation unit 102 of the data processing apparatus 10-0 compares the keys “8” and “0” at the key column of the left structure of the own node with the keys “7” and “8” at the key column of the right structure of the node 1. In this case, the key comparing condition “>” is satisfied. As a result, the operation unit 102 adds the number of occurrences “1” corresponding to the keys “7” and “8” of the right structure to the number of forward presences corresponding to the keys “8” and “0” of the left structure. Then, the operation unit 102 lowers the reference position in the right structure by one. Thus, the number of forward presences at the operating position “1” of the left structure is updated from “2” to “3” and the reference position in the right structure is updated from “2” to “3”.

Next, the operation unit 102 of the data processing apparatus 10-0 compares the keys “8” and “0” at the key column of the left structure of the own node with the keys “8” and “10” at the key column of the right structure of the node 1. In this case, the key comparing condition “>” is not satisfied. As a result, the operation unit 102 would lower the operating position in the left structure by one. However, it is not possible to further lower the operating position. Therefore, the operation unit 102 ends the L-operation.

S75-0-2) The operation unit 102 of the data processing apparatus 10-0 compares the keys “6” and “6” at the key column of the left structure of the own node with the keys “7” and “4” at the key column of the right structure of the node 2. In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-0 compares the keys “8” and “0” at the key column of the left structure of the own node with the keys “7” and “4” at the key column of the right structure of the node 2. In this case, the key comparing condition “>” is satisfied. As a result, the operation unit 102 adds the number of occurrences “2” corresponding to the keys “7” and “4” of the right structure to the number of forward presences corresponding to the keys “8” and “0” of the left structure. Then, the operation unit 102 lowers the reference position in the right structure by one. Thus, the number of forward presences at the operating position “1” of the left structure is updated from “0” to “2” and the reference position in the right structure is updated from “0” to “1”.

Next, the operation unit 102 of the data processing apparatus 10-0 compares the keys “8” and “0” at the key column of the left structure of the own node with the keys “8” and “3” at the key column of the right structure of the node 2. In this case, the key comparing condition “>” is not satisfied. As a result, the operation unit 102 would lower the operating position in the left structure by one. However, it is not possible to further lower the operating position. Therefore, the operation unit 102 ends the L-operation.

S76-0) Next, the operation unit 102 of the data processing apparatus 10-0 calculates a total of the numbers of forward presences of the left structures. That is, the operation unit 102 of the data processing apparatus 10-0 calculates a total of the respective numbers of forward presences of the left structure that is for comparison with the right structure of the node 0, of the left structure that is for comparison with the right structure of the node 1, and of the left structure that is for comparison with the right structure of the node 2. Thus, the (total) number of forward presences corresponding to the age “6” and the oldGOrd value “6” is “0”; the (total) number of forward presences corresponding to the age “8” and the oldGOrd value “0” is “7”.

S77-0) Next, the operation unit 102 of the data processing apparatus 10-0 aggregates the (total) numbers of forward presences calculated in S76-0. That is, the operation unit 102 of the data processing apparatus 10-0 leaves the number of forward presences corresponding to the age “6” and the oldGOrd value “6” as it is while changing the number of forward presences corresponding to the age “8” and the oldGOrd value “0” to be the number of forward presences corresponding to the age “6” and the oldGOrd value “6”+the number of forward presences corresponding to the age “8” and the oldGOrd value “0”.

Thus, the number of forward presences corresponding to the age “6” and the oldGOrd value “6” is “0”; the number of forward presences corresponding to the age “0” and the oldGOrd value “8” is “7”. These numbers of forward presences will be used as start numbers of GOrd values on a per-oldGPrd basis in the node 0. In this case, the start number of a GOrd value for the age “6” and the oldGOrd value “6” in the node 0 is “0”; the start number of a GOrd value for the age “8” and the oldGOrd value “0” in the node 0 is “6”.

S78-0) Next, the operation unit 102 of the data processing apparatus 10-0 uses the aggregate numbers of forward presences calculated in S77-0 and the numbers of occurrences obtained in S72 and updates the GOrd list of the own node generated in S71. That is, the operation unit 102 of the data processing apparatus 10-0 stores, in the GOrd list, on a per-age-and-oldGOrd basis, values that start from the aggregate numbers of forward presences and that are incremented from the top places, one by one, the numbers of times corresponding to the numbers of occurrences. Thus, in the GOrd list of the node 0, a GOrd value “0” is stored at the storing position “0”, a GOrd value “1” is stored at the storing position “1”, a GOrd value “7” is stored at the storing position “2”, and a GOrd value “8” is stored at the storing position “3”.

S75-1) The operation unit 102 of the data processing apparatus 10-1 performs an L-operation with a key comparing condition “>”. In detail, the operation unit 102 of the data processing apparatus 10-1 executes the following S75-1-0 through S75-1-2. In this regard, in some cases, for parallel processing of S75-1-0 through S75-1-2 described below, the operation unit 102 of the data processing apparatus 10-1 uses the numbers of forward presences included in the left structures stored in different storage areas, respectively. In other words, in some cases, for parallel processing, the operation unit 102 of the data processing apparatus 10-1 uses the number of forward presences included in the left structure that is for comparison with the right structure of the node 0, the number of forward presences included in the left structure that is for comparison with the right structure of the node 1, and the number of forward presences included in the left structure that is for comparison with the right structure of the node 2. Note that because a Global L-operation has the above-described feature 1, the following S75-1-0 through S75-1-2 may be executed in any order.

S75-1-0) The operation unit 102 of the data processing apparatus 10-1 compares the keys “6” and “9” at the key column of the left structure of the own node with the keys “6” and “6” at the key column of the right structure of the node 0. In this case, the key comparing condition “>” is satisfied. As a result, the operation unit 102 adds the number of occurrences “2” corresponding to the keys “6” and “6” of the right structure to the number of forward presences corresponding to the keys “6” and “9” of the left structure. Then, the operation unit 102 lowers the reference position in the right structure by one. Thus, the number of forward presences at the operating position “0” of the left structure is updated from “0” to “2” and the reference position in the right structure is updated from “0” to “1”.

Next, the operation unit 102 of the data processing apparatus 10-1 compares the keys “6” and “9” at the key column of the left structure of the own node with the keys “8” and “0” at the key column of the right structure of the node 0. In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-1 compares the keys “7” and “2” at the key column of the left structure of the own node with the keys “8” and “0” at the key column of the right structure of the node 0. In this case, the key comparing condition “>” is not satisfied. As a result, the operation unit 102 lowers the operating position in the left structure by one. Thus, the operating position in the left structure is updated from “1” to “2”.

Next, the operation unit 102 of the data processing apparatus 10-1 compares the keys “7” and “8” at the key column of the left structure of the own node with the keys “8” and “0” at the key column of the right structure of the node 0. In this case, the key comparing condition “>” is not satisfied. As a result, the operation unit 102 lowers the operating position in the left structure by one. Thus, the operating position in the left structure is updated from “2” to “3”.

Next, the operation unit 102 of the data processing apparatus 10-1 compares the keys “8” and “10” at the key column of the left structure of the own node with the keys “8” and “0” at the key column of the right structure of the node 0. In this case, the key comparing condition “>” is satisfied. As a result, the operation unit 102 adds the number of occurrences “2” corresponding to the keys “8” and “0” of the right structure to the number of forward presences corresponding to the keys “8” and “10” of the left structure. Then, the operation unit 102 would lower the reference position in the right structure by one. However, it is not possible to further lower the reference position. Therefore, the operation unit 102 ends the L-operation. Thus, the number of forward presences at the operating position “3” of the left structure is updated from “0” to “2”.

S75-1-1) The operation unit 102 of the data processing apparatus 10-1 compares the keys “6” and “9” at the key column of the left structure of the own node with the keys “6” and “9” at the key column of the right structure of the own node (the node 1). In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-1 compares the keys “7” and “2” at the key column of the left structure of the own node with the keys “6” and “9” at the key column of the right structure of the own node (the node 1). In this case, the key comparing condition “>” is satisfied. As a result, the operation unit 102 adds the number of occurrences “1” corresponding to the keys “6” and “9” of the right structure to the number of forward presences corresponding to the keys “7” and “2” of the left structure. Then, the operation unit 102 lowers the reference position in the right structure by one. Thus, the number of forward presences at the operating position “1” of the left structure is updated from “0” to “1” and the reference position in the right structure is updated from “0” to “1”.

Next, the operation unit 102 of the data processing apparatus 10-1 compares the keys “7” and “2” at the key column of the left structure of the own node with the keys “7” and “2” at the key column of the right structure of the own node (the node 1). In this case, the key comparing condition “>” is not satisfied. As a result, the operation unit 102 lowers the operating position in the left structure by one. Thus, the operating position in the left structure is updated from “1” to “2”.

Next, the operation unit 102 of the data processing apparatus 10-1 compares the keys “7” and “8” at the key column of the left structure of the own node with the keys “7” and “2” at the key column of the right structure of the own node (the node 1). In this case, the key comparing condition “>” is satisfied. As a result, the operation unit 102 adds the number of occurrences “1” corresponding to the keys “7” and “2” of the right structure to the number of forward presences corresponding to the keys “7” and “8” of the left structure. Then, the operation unit 102 lowers the reference position in the right structure by one. Thus, the number of forward presences at the operating position “2” of the left structure is updated from “0” to “1” and the reference position in the right structure is updated from “1” to “2”.

Next, the operation unit 102 of the data processing apparatus 10-1 compares the keys “7” and “8” at the key column of the left structure of the own node with the keys “7” and “8” at the key column of the right structure of the own node (the node 1). In this case, the key comparing condition “>” is not satisfied. As a result, the operation unit 102 lowers the operating position in the left structure by one. Thus, the operating position in the left structure is updated from “2” to “3”.

Next, the operation unit 102 of the data processing apparatus 10-1 compares the keys “8” and “10” at the key column of the left structure of the own node with the keys “7” and “8” at the key column of the right structure of the own node (the node 1). In this case, the key comparing condition “>” is satisfied. As a result, the operation unit 102 adds the number of occurrences “1” corresponding to the keys “7” and “8” of the right structure to the number of forward presences corresponding to the keys “8” and “10” of the left structure. Then, the operation unit 102 lowers the reference position in the right structure by one. Thus, the number of forward presences at the operating position “3” of the left structure is updated from “0” to “1” and the reference position in the right structure is updated from “2” to “3”.

Next, the operation unit 102 of the data processing apparatus 10-1 compares the keys “8” and “10” at the key column of the left structure of the own node with the keys “8” and “10” at the key column of the right structure of the own node (the node 1). In this case, the key comparing condition “>” is not satisfied. As a result, the operation unit 102 would lower the operating position in the left structure by one. However, it is not possible to further lower the operating position. Therefore, the operation unit 102 ends the L-operation.

S75-1-2) The operation unit 102 of the data processing apparatus 10-1 compares the keys “6” and “9” at the key column of the left structure of the own node with the keys “7” and “4” at the key column of the right structure of the node 2. In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-1 compares the keys “7” and “2” at the key column of the left structure of the own node with the keys “7” and “4” at the key column of the right structure of the node 2. In this case, the key comparing condition “>” is not satisfied. As a result, the operation unit 102 lowers the operating position in the left structure by one. Thus, the operating position in the left structure is updated from “1” to “2”.

Next, the operation unit 102 of the data processing apparatus 10-1 compares the keys “7” and “8” at the key column of the left structure of the own node with the keys “7” and “4” at the key column of the right structure of the node 2. In this case, the key comparing condition “>” is satisfied. As a result, the operation unit 102 adds the number of occurrences “2” corresponding to the keys “7” and “4” of the right structure to the number of forward presences corresponding to the keys “7” and “8” of the left structure. Then, the operation unit 102 lowers the reference position in the right structure by one. Thus, the number of forward presences at the operating position “2” of the left structure is updated from “0” to “2” and the reference position in the right structure is updated from “0” to “1”.

Next, the operation unit 102 of the data processing apparatus 10-1 compares the keys “7” and “8” at the key column of the left structure of the own node with the keys “8” and “3” at the key column of the right structure of the node 2. In this case, the key comparing condition “>” is not satisfied. As a result, the operation unit 102 lowers the operating position in the left structure by one. Thus, the operating position in the left structure is updated from “2” to “3”.

Next, the operation unit 102 of the data processing apparatus 10-1 compares the keys “8” and “10” at the key column of the left structure of the own node with the keys “8” and “3” at the key column of the right structure of the node 2. In this case, the key comparing condition “>” is satisfied. As a result, the operation unit 102 adds the number of occurrences “1” corresponding to the keys “8” and “3” of the right structure to the number of forward presences corresponding to the keys “8” and “10” of the left structure. Then, the operation unit 102 lowers the reference position in the right structure by one. Thus, the number of forward presences at the operating position “3” of the left structure is updated from “0” to “1” and the reference position in the right structure is updated from “1” to “2”.

Next, the operation unit 102 of the data processing apparatus 10-1 compares the keys “8” and “10” at the key column of the left structure of the own node with the keys “8” and “11” at the key column of the right structure of the node 2. In this case, the key comparing condition “>” is not satisfied. As a result, the operation unit 102 would lower the operating position in the left structure by one. However, it is not possible to further lower the operating position. Therefore, the operation unit 102 ends the L-operation.

S76-1) Next, the operation unit 102 of the data processing apparatus 10-1 calculates a total of the numbers of forward presences of the left structures. That is, the operation unit 102 of the data processing apparatus 10-1 calculates a total of the respective numbers of forward presences of the left structure that is for comparison with the right structure of the node 0, of the left structure that is for comparison with the right structure of the node 1, and of the left structure that is for comparison with the right structure of the node 2. Thus, the (total) number of forward presences corresponding to the age “6” and the oldGOrd value “9” is “2”; the (total) number of forward presences corresponding to the age “7” and the oldGOrd value “2” is “1”; the (total) number of forward presences corresponding to the age “7” and the oldGOrd value “8” is “3”; and the (total) number of forward presences corresponding to the age “8” and the oldGOrd value “10” is “4”.

S77-1) Next, the operation unit 102 of the data processing apparatus 10-1 aggregates the (total) numbers of forward presences calculated in S76-1. That is, the operation unit 102 of the data processing apparatus 10-1 stores, as the number of forward presences for each key, the total of the respective numbers of forward presences for the key and all of the smaller keys.

Thus, the number of forward presences corresponding to the age “6” and the oldGOrd value “9” is “2”; the number of forward presences corresponding to the age “7” and the oldGOrd value “2” is “3; the number of forward presences corresponding to the age “7” and the oldGOrd value “8” is “6”; and the number of forward presences corresponding to the age “8” and the oldGOrd value “10” is “10”. These numbers of forward presences will be used as start numbers of GOrd values on a per-age-and-oldGPrd basis in the node 1. In this case, the start number of a GOrd value for the age “6” and the oldGOrd “9” value in the node 1 is “2”; the start number of a GOrd value for the age “7” and the oldGOrd value “2” in the node 1 is “3”; the start number of a GOrd value for the age “7” and the oldGOrd value “8” in the node 1 is “6”; and the start number of a GOrd value for the age “8” and the oldGOrd value “10” in the node 1 is “10”.

S78-1) Next, the operation unit 102 of the data processing apparatus 10-1 uses the aggregate numbers of forward presences calculated in S77-1 and the numbers of occurrences obtained in S72 and updates the GOrd list of the own node generated in S71. That is, the operation unit 102 of the data processing apparatus 10-1 stores, in the GOrd list, on a per-age-and-oldGOrd basis, values that start from the numbers of forward presences and that are incremented from the top places, one by one, the numbers of times corresponding to the numbers of occurrences. Thus, in the GOrd list of the node 1, a GOrd value “2” is stored at the storing position “0”, a GOrd value “3” is stored at the storing position “1”, a GOrd value “6” is stored at the storing position “2”, and a GOrd value “10” is stored at the storing position “3”.

S75-2) The operation unit 102 of the data processing apparatus 10-2 performs an L-operation with a key comparing condition “>”. In detail, the operation unit 102 of the data processing apparatus 10-2 executes the following S75-2-0 through S75-2-2. In this regard, in some cases, for parallel processing of S75-2-0 through S75-2-2 described below, the operation unit 102 of the data processing apparatus 10-2 uses the numbers of forward presences included in the left structures stored in different storage areas, respectively. In other words, in some cases, for parallel processing, the operation unit 102 of the data processing apparatus 10-2 uses the number of forward presences included in the left structure that is for comparison with the right structure of the node 0, the number of forward presences included in the left structure that is for comparison with the right structure of the node 1, and the number of forward presences included in the left structure that is for comparison with the right structure of the node 2. Note that because a Global L-operation has the above-described feature 1, the following S75-2-0 through S75-2-2 may be executed in any order.

S75-2-0) The operation unit 102 of the data processing apparatus 10-2 compares the keys “7” and “4” at the key column of the left structure of the own node with the keys “6” and “6” at the key column of the right structure of the node 0. In this case, the key comparing condition “>” is satisfied. As a result, the operation unit 102 adds the number of occurrences “2” corresponding to the keys “6” and “6” of the right structure to the number of forward presences corresponding to the keys “7” and “4” of the left structure. Then, the operation unit 102 lowers the reference position in the right structure by one. Thus, the number of forward presences at the operating position “0” of the left structure is updated from “0” to “2” and the reference position in the right structure is updated from “0” to “1”.

Next, the operation unit 102 of the data processing apparatus 10-2 compares the keys “7” and “4” at the key column of the left structure of the own node with the keys “8” and “0” at the key column of the right structure of the node 0. In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-2 compares the keys “8” and “3” at the key column of the left structure of the own node with the keys “8” and “0” at the key column of the right structure of the node 0. In this case, the key comparing condition “>” is satisfied. As a result, the operation unit 102 adds the number of occurrences “2” corresponding to the keys “8” and “0” of the right structure to the number of forward presences corresponding to the keys “8” and “3” of the left structure. Then, the operation unit 102 would lower the reference position in the right structure by one. However, it is not possible to further lower the reference position. Therefore, the operation unit 102 ends the L-operation. Thus, the number of forward presences at the operating position “3” of the left structure is updated from “0” to “2”.

S75-2-1) The operation unit 102 of the data processing apparatus 10-2 compares the keys “7” and “4” at the key column of the left structure of the own node with the keys “6” and “9” at the key column of the right structure of the node 1. In this case, the key comparing condition “>” is satisfied. As a result, the operation unit 102 adds the number of occurrences “1” corresponding to the keys “6” and “9” of the right structure to the number of forward presences corresponding to the keys “7” and “4” of the left structure. Then, the operation unit 102 lowers the reference position in the right structure by one. Thus, the number of forward presences at the operating position “0” of the left structure is updated from “0” to “1” and the reference position in the right structure is updated from “0” to “1”.

Next, the operation unit 102 of the data processing apparatus 10-2 compares the keys “7” and “4” at the key column of the left structure of the own node with the keys “7” and “2” at the key column of the right structure of the node 1. In this case, the key comparing condition “>” is satisfied. As a result, the operation unit 102 adds the number of occurrences “1” corresponding to the keys “7” and “2” of the right structure to the number of forward presences corresponding to the keys “7” and “4” of the left structure. Then, the operation unit 102 lowers the reference position in the right structure by one. Thus, the number of forward presences at the operating position “0” of the left structure is updated from “1” to “2” and the reference position in the right structure is updated from “1” to “2”.

S75-1-1) The operation unit 102 of the data processing apparatus 10-2 compares the keys “7” and “4” at the key column of the left structure of the own node with the keys “7” and “9” at the key column of the right structure of the node 1. In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-2 compares the keys “8” and “3” at the key column of the left structure of the own node with the keys “7” and “9” at the key column of the right structure of the node 1. In this case, the key comparing condition “>” is satisfied. As a result, the operation unit 102 adds the number of occurrences “1” corresponding to the keys “7” and “9” of the right structure to the number of forward presences corresponding to the keys “8” and “3” of the left structure. Then, the operation unit 102 lowers the reference position in the right structure by one. Thus, the number of forward presences at the operating position “1” of the left structure is updated from “0” to “1” and the reference position in the right structure is updated from “2” to “3”.

Next, the operation unit 102 of the data processing apparatus 10-2 compares the keys “8” and “3” at the key column of the left structure of the own node with the keys “8” and “10” at the key column of the right structure of the node 1. In this case, the key comparing condition “>” is not satisfied. As a result, the operation unit 102 lowers the operating position in the left structure by one. Thus, the operating position in the left structure is updated from “1” to “2”.

Next, the operation unit 102 of the data processing apparatus 10-2 compares the keys “8” and “11” at the key column of the left structure of the own node with the keys “8” and “10” at the key column of the right structure of the node 1. In this case, the key comparing condition “>” is satisfied. As a result, the operation unit 102 adds the number of occurrences “1” corresponding to the keys “8” and “10” of the right structure to the number of forward presences corresponding to the keys “8” and “11” of the left structure. Then, the operation unit 102 would lower the reference position in the right structure by one. However, it is not possible to further lower the reference position. Therefore, the operation unit 102 ends the L-operation. Thus, the number of forward presences at the operating position “2” of the left structure is updated from “0” to “1”.

S75-2-2) The operation unit 102 of the data processing apparatus 10-2 compares the keys “7” and “4” at the key column of the left structure of the own node with the keys “7” and “4” at the key column of the right structure of the own node (the node 2). In this case, the key comparing condition “>” is not satisfied. As a result, the operation unit 102 lowers the operating position in the left structure by one. Thus, the operating position in the left structure is updated from “0” to “1”.

Next, the operation unit 102 of the data processing apparatus 10-2 compares the keys “8” and “3” at the key column of the left structure of the own node with the keys “7” and “4” at the key column of the right structure of the own node (the node 2). In this case, the key comparing condition “>” is satisfied. As a result, the operation unit 102 adds the number of occurrences “2” corresponding to the keys “7” and “4” of the right structure to the number of forward presences corresponding to the keys “8” and “3” of the left structure. Then, the operation unit 102 lowers the reference position in the right structure by one. Thus, the number of forward presences at the operating position “1” of the left structure is updated from “0” to “2” and the reference position in the right structure is updated from “0” to “1”.

Next, the operation unit 102 of the data processing apparatus 10-2 compares the keys “8” and “3” at the key column of the left structure of the own node with the keys “8” and “3” at the key column of the right structure of the own node (the node 2). In this case, the key comparing condition “>” is not satisfied. As a result, the operation unit 102 lowers the operating position in the left structure by one. Thus, the operating position in the left structure is updated from “1” to “2”.

Next, the operation unit 102 of the data processing apparatus 10-2 compares the keys “8” and “11” at the key column of the left structure of the own node with the keys “8” and “3” at the key column of the right structure of the own node (the node 2). In this case, the key comparing condition “>” is satisfied. As a result, the operation unit 102 adds the number of occurrences “1” corresponding to the keys “8” and “3” of the right structure to the number of forward presences corresponding to the keys “8” and “11” of the left structure. Then, the operation unit 102 lowers the reference position in the right structure by one. Thus, the number of forward presences at the operating position “2” of the left structure is updated from “0” to “1” and the reference position in the right structure is updated from “1” to “2”.

Next, the operation unit 102 of the data processing apparatus 10-2 compares the keys “8” and “11” at the key column of the left structure of the own node with the keys “8” and “11” at the key column of the right structure of the own node (the node 2). In this case, the key comparing condition “>” is not satisfied. As a result, the operation unit 102 would lower the operating position in the left structure by one. However, it is not possible to further lower the operating position. Therefore, the operation unit 102 ends the L-operation.

S76-2) Next, the operation unit 102 of the data processing apparatus 10-2 calculates a total of the numbers of forward presences of the left structures. That is, the operation unit 102 of the data processing apparatus 10-2 calculates a total of the respective numbers of forward presences of the left structure that is for comparison with the right structure of the node 0, of the left structure that is for comparison with the right structure of the node 1, and of the left structure that is for comparison with the right structure of the node 2. Thus, the (total) number of forward presences corresponding to the age “7” and the oldGOrd value “4” is “4”; the (total) number of forward presences corresponding to the age “8” and the oldGOrd value “3” is “5”; and the (total) number of forward presences corresponding to the age “8” and the oldGOrd value “11” is “2”.

S77-2) Next, the operation unit 102 of the data processing apparatus 10-2 aggregates the (total) numbers of forward presences calculated in S76-2. That is, the operation unit 102 of the data processing apparatus 10-2 stores, as the number of forward presences for each key, the total of the respective numbers of forward presences for the key and all of the smaller keys.

Thus, the number of forward presences corresponding to the age “7” and the oldGOrd value “4” is “4”; the number of forward presences corresponding to the age “8” and the oldGOrd value “3” is “9; and the number of forward presences corresponding to the age “8” and the oldGOrd value “11” is “11”. These numbers of forward presences will be used as start numbers of GOrd values on a per-age-and-oldGPrd basis in the node 2. In this case, the start number of a GOrd value for the age “7” and the oldGOrd value “4” in the node 2 is “4”; the start number of a GOrd value for the age “8” and the oldGOrd value “3” in the node 2 is “9”; and the start number of a GOrd value for the age “8” and the oldGOrd value “11” in the node 2 is “11”.

S78-2) Next, the operation unit 102 of the data processing apparatus 10-2 uses the aggregate numbers of forward presences calculated in S77-2 and the numbers of occurrences obtained in S72 and updates the GOrd list of the own node generated in S71. That is, the operation unit 102 of the data processing apparatus 10-2 stores, in the GOrd list, on a per-age-and-oldGOrd basis, values that start from the numbers of forward presences and that are incremented from the top places, one by one, the numbers of times corresponding to the numbers of occurrences. Thus, in the GOrd list of the node 2, a GOrd value “4” is stored at the storing position “0”, a GOrd value “5” is stored at the storing position “1”, a GOrd value “9” is stored at the storing position “2”, and a GOrd value “11” is stored at the storing position “3”.

Thus, the GOrd values are stored in each GOrd list generated in S71. Thus, in each data processing apparatus 10, the partial table provided with the GOrd values (and the record numbers) is obtained, and, through the GOrd values, a sorting result (i.e., a sorting result of sorting of a subset) with respect to all of the data processing apparatuses 10 (a sorting result of sorting of a subset) is obtained.

<Splitting of Structure>

Each of a right structure and a left structure may have a very large number of rows, and therefore, there is a case where, upon data processing, a right structure or a left structure is desired to be split. Especially, right structures are exchanged mutually among nodes, and therefore, there is a case where a right structure is desired to be split into such sizes that communication of the right structure can be easily implemented.

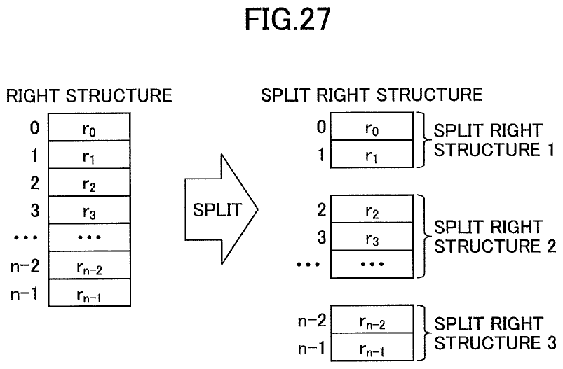

Below, a case where a right structure is split will now be described with reference to FIG. 27. FIG. 27 illustrates an example of splitting a right structure. Also a left structure can be split in the same way as a way of splitting a right structure.

As illustrated in FIG. 27, assuming that the number of rows in a right structure is n and the i-th row has a key rᵢ (0≤i≤n−1) the right structure can be split into any number (however, smaller than or equal to n) of right structures where consecutive rows constitute one of the right structures. Hereinafter, each right structure obtained from splitting will also be referred to as a “split right structure”. In a case where a right structure is split in the order from the top into N splits, the resulting split right structures will be referred to, in the order from the top, a “split right structure 1”, a “split right structure 2”, and a “split right structure N”. FIG. 27 illustrates one example of N=3, and illustrates a case where a right structure is split into three splits, i.e., a split right structure 1, a split right structure 2, and a split right structure 3.

Note that, according to the definition of an L-operation, an L-operation performed between every split right structure and a left structure has the same operation result as that of an L-operation performed between the (not split) right structure and the left structure.

In this regard, for example, in a case of performing an L-operation between every split right structure and a left structure, the operation unit 102 may start, each time of receiving a split right operation, from an L-operation between the operating position “0” of the split right structure and the left structure. However, this case is not satisfactorily efficient.

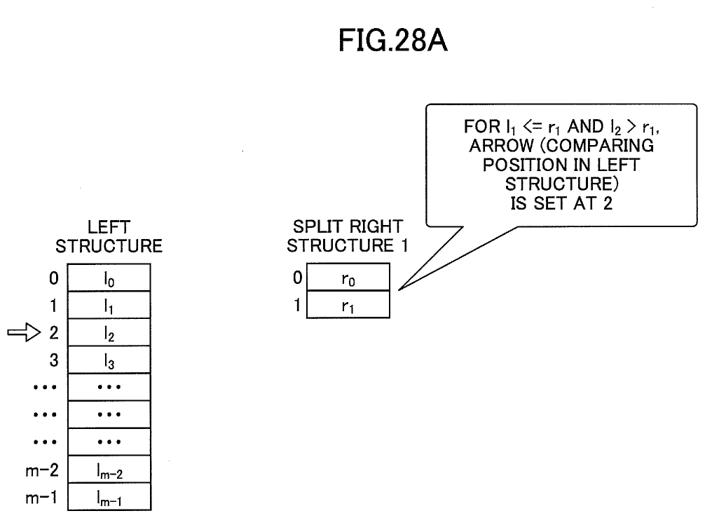

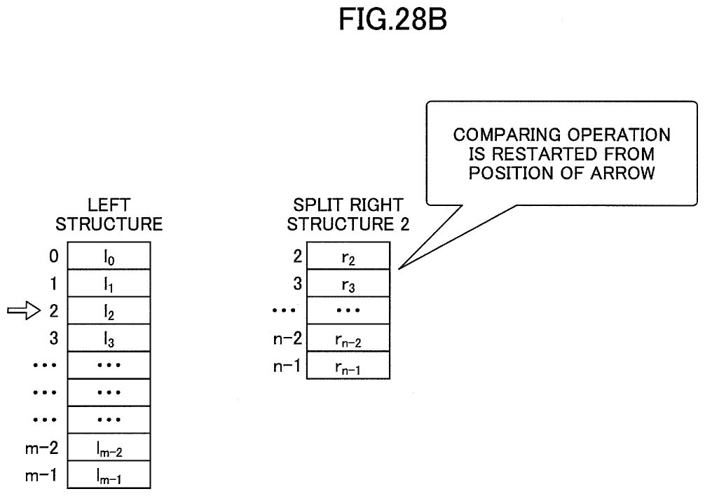

Therefore, in a case where it is guaranteed that every split right structure is received in the stated order of a “split right structure 1”, a “split right structure 2”, and a “split right structure N”, it is possible to execute L-operations without degrading the efficiency. A description will now be made with reference to FIG. 28 for a case where, assuming that the number of rows of a left structure is m and the j-th row has a key lⱼ (0≤j≤m−1) and assuming N=2. FIG. 28 illustrates an example of improving the efficiency of an operation of comparing between a left structure and a split right structure.

As illustrated in FIG. 28A, in an L-operation between a left structure and a split right structure 1, an operating position is determined as “2” for “l₁≤r₁” and “l₂>r₁.”. Then, as illustrated in FIG. 28B, in an L-operation between a left structure and a split right structure 2, the L-operation is performed from an operating position “2”. Thus, in the L-operation between the left structure and the split right structure 2, it is not necessary to perform key comparing operations for the operating positions “0” through “1”. Thus, it is possible to perform L-operations without degrading the efficiency even if a structure has been split.

The present invention is not limited to the above-mentioned specifically disclosed embodiments, and various modifications or changes can be made without departing from the claimed invention.

What is claimed is:

1. A data processing system comprising a plurality of nodes that store tables, respectively, each of the tables storing one or more records,
wherein
each of the nodes includes:
processing circuitry configured to:
generate, from a table of the tables stored by an own node, a right structure that is used as a referred-side structure in an L-operation;
generate, from the right structure, a left structure that is used as an operated-side structure in an L-operation;
transmit the right structure generated by the processing circuitry to another node;
receive a right structure generated by another node;
perform an L-operation between the left structure and each of the right structure generated by the processing circuitry and the right structure received by the processing circuitry, and
determine, for the one or more records stored by the table stored by the own node, corresponding positions of an order of all records stored by the tables that are stored by the plurality of nodes, respectively.

2. The data processing system as claimed in claim 1, wherein
as a result of the processing circuitry determining the positions in the order for the one or more records stored by the table stored by the own node, data processing including at least searching, calculating a total, and sorting among the all records stored by the tables that are stored by the plurality of nodes, respectively, is implemented.

3. The data processing system as claimed in claim 1, wherein
a left structure has a structure where a key and a result storing area are included in each row and one or more rows are arranged in an ascending order or a descending order of keys,
a right structure has a structure where a key and a predetermined value are included in each row and one or more rows are arranged in an ascending order or a descending order of keys, and
an L-operation is an operation to compare keys of a left structure with keys of a right structure in an ascending order or a descending order and, in response to a satisfaction of a comparing condition, to store an operating result obtained with the use of a value associated with a corresponding key of the right structure in a result storing area of the left structure associated with a corresponding key.

4. The data processing system as claimed in claim 3, wherein
a comparing condition is a condition that a key of a left structure is greater than or smaller than a key of a right structure or a condition that a key of a left structure is equal to a key of a right structure.

5. The data processing system as claimed in claim 3, wherein
each of a key of a left structure and a key of a right structure includes a set of a plurality of values.

6. The data processing system as claimed in claim 1, wherein
node numbers are provided to the plurality of nodes, and
the table stored by each of the plurality of nodes is a table from among tables obtained from splitting a predetermined table and corresponds to a node number.

7. The data processing system as claimed in claim 1,
wherein
the processing circuitry is configured to:
split at least one of a right structure and a left structure, and
in response to splitting a right structure, transmit a split right structure to another node.

8. A data processing apparatus communicatively connected with one or more other data processing apparatuses that store tables,
respectively, each of the tables storing one or more records, the data processing apparatus comprising
processing circuitry configured to:
generate, from a table of the tables stored by the data processing apparatus, a right structure that is used as a referred-side structure in an L-operation;
generate, from the right structure, a left structure that is used as an operated-side structure in an L-operation;
transmit the right structure generated by the processing circuitry to another data processing apparatus;
receive a right structure generated by another data processing apparatus;
perform an L-operation between the left structure and each of the right structure generated by the processing circuitry and the right structure received by the processing circuitry, and
determine, for the one or more records stored by the table stored by the data processing apparatus, corresponding positions in an order of all records stored by the tables that are stored by the other data processing apparatuses, respectively.

9. A data processing method for a data processing apparatus communicatively connected with one or more other data processing apparatuses that store tables, respectively, each of the tables storing one or more records, the data processing method including:
generating, by processing circuitry of the data processing apparatus, from a table of the tables stored by the data processing apparatus, a right structure that is used as a referred-side structure in an L-operation;
generating, by the processing circuitry of the data processing apparatus, from the right structure, a left structure that is used as an operated-side structure in an L-operation;
transmitting, by the processing circuitry of the data processing apparatus, the right structure generated in the generating to another data processing apparatus;
receiving, by the processing circuitry of the data processing apparatus, a right structure generated by another data processing apparatus;
performing, by the processing circuitry of the data processing apparatus, an L-operation between the left structure and each of the right structure generated in the generating and the right structure received in the receiving, and
determining, by the processing circuitry of the data processing apparatus, for the one or more records stored by the table stored by the data processing apparatus, corresponding positions in an order of all records stored by the tables that are stored by the other data processing apparatuses, respectively.

10. A non-transitory recording medium storing a program for a data processing apparatus communicatively connected with one or more other data processing apparatuses that store tables, respectively, each of the tables storing one or more records, the program causing the data processing apparatus to execute the data processing method claimed in claim 9.
